(19) United States
(12) Patent Application Publication
(10) Pub. No.: US 2026/0271889 A1
(43) Pub. Date: Sep. 17, 2026

(54) METHODS AND SYSTEMS FOR DETECTING AND IDENTIFYING AN ANIMAL AND ASSOCIATED ANIMAL BEHAVIOR RELATIVE TO A SYSTEM OF PET HEALTH ISSUES

(71) Applicant: Automated Pet Care Products, LLC D/B/A Whisker, Auburn Hills, MI (US)

(72) Inventors: Jeff Skutnick, Indian River, MI (US); Brad Baxter, Bloomfield Hills, MI (US); Jacob Zuppke, Bloomfield Hills, MI (US); Gerardo Gomez Garrido, Longview, TX (US); Parker Goby, Auburn Hills, MI (US); Nate Brandeburg, Auburn Hills, MI (US); Alex Mason, Auburn Hills, MI (US); Carter Brown, Auburn Hills, MI (US); Akito Nozaki, Auburn Hills, MI (US); Amir Kashani, Irvine, CA (US); Nick Munck, Auburn Hills, MI (US)

(21) Appl. No.: 19/166,158

(22) PCT Filed: Mar. 18, 2024
(86) PCT No.: PCT/US2024/020406

§ 371 Date: Sep. 17, 2025

Related U.S. Application Data
(60) Provisional application No. 63/490,990, filed on Mar. 17, 2023.
(60) Provisional application No. 63/490,910, filed on Mar. 17, 2023.

(51) Int. Cl. A01K 29/00; A01K 1/01; A01K 5/02; A01K 7/02; G06V 10/25; G06V 10/774; G06V 40/10

(52) U.S. Cl. CPC A01K 29/007; A01K 1/0114; A01K 5/02; A01K 7/02; G06V 10/25; G06V 10/774; G06V 40/10

(57) ABSTRACT

One or more methods for automated animal detection, automated animal identification, automated behavior identification, automated trend and/or pattern identification, and automated notifications. The one or more methods may employ a camera for receiving incoming image signals and converting to a video stream. The video stream may then be converted into image data which may be analyzed by one or more processors and stored in one or more storage mediums. One or more models may be executed on the incoming image data to detect the presence of an animal, an identification of the animal, behavior of the animal, and/or trends of the animal. The methods may be useful with pet health devices, such as litter devices, water dispensers, and feeders.

### CROSS-REFERENCE TO RELATED APPLICATIONS

This application claims priority from U.S. Provisional Application Nos. 63/490,990 and 63/490,910, filed on Mar. 17, 2023, and which are incorporated herein by reference in their entirety for all purposes.

### FIELD

The present disclosure relates to methods and systems for detecting an animal's presence, identifying an animal with substantial accuracy, and even learning patterns and trends in behavior of individual animals. The present disclosure may relate to visual detection and visual identification of an animal within or near one or more pet health devices.

### BACKGROUND

Automated devices targeted to filling the needs of domestic animals and their owners often include a number of onboard sensors. These sensors are advantageous in monitoring performance of the device itself and monitoring usage of the device by an animal. For example, the automated litter device disclosed in PCT Publication No. WO2020/219849A1, incorporated herein by reference in its entirety for all purposes, makes use of one or more sensors near the entry opening to determine the presence of an animal entering and/or exiting the chamber and a level of litter within the chamber. As another example, the automated feeder disclosed in PCT Publication No. WO2020/061307A1, incorporated herein by reference in its entirety for all purposes, makes use of a sensing tower to determine the volume of food available and one or more chute sensors to determine the level of food available for consumption.

To simplify manufacturing while potentially providing more reliable data, it would be useful to replace a number of sensors with a single sensing mechanism that could detect animal behavior with pet devices and even detect performance and status of the pet devices. It could also be beneficial to supplement the varying sensors used today with another sensing mechanism to aid with data validation.

These automated pet devices via their already existing sensors collect a vast amount of data regarding use by an animal. It would be advantageous to determine behavior and health of an animal based on the collected data. But to allow for accurate collection of the data and associating it with a specific animal, the animal's identification must also be determined.

Today's pet health devices, if cooperating, must be part of an established network of devices. In other words, the devices must typically originate from the same company and be developed to work together. It would be beneficial to provide for a sensing device compatible with a plurality of health devices across varying brands which is still able to detect and identify an animal using those devices, and even determine patterns of behavior associated with that animal.

### SUMMARY

The present teachings relate to a method for automated animal detection executed by one or more computing devices comprising: a) receiving one or more incoming image data signals by a camera; b) transmitting the one or more incoming image data signals from the camera to a processor; c) converting the one or more incoming image data signals to one or more image data by the processor and storing in a storage medium; d) executing an animal detection model and analyzing the image data to determine a presence or an absence of an animal; and e) transmitting the presence or the absence as data to one or more other algorithms, applications, processors, databases, or any combination thereof.

A method for automated animal detection executed by one or more computing devices comprising: a) receiving one or more incoming image data signals by a camera upon the camera capturing an incoming video stream resulting from an animal approaching a pet health device, the camera, or both; b) transmitting the one or more incoming image data signals from the camera to one or more processors; c) converting the one or more incoming image data signals to one or more image data by the one or more processors and storing in one or more storage mediums; d) executing an animal detection model and analyzing the image data to determine a presence or an absence of an animal at the pet health device; and e) instructing one or more controllers of the pet health device to execute and/or stop one or more operations of the pet health device.

The present teachings relate to a method for automated animal identification executed by one or more computing devices comprising: a) receiving one or more incoming image data signals by a camera; b) transmitting the one or more incoming image data signals from the camera to a processor; c) converting the one or more incoming image data signals to one or more image data by the processor and storing in a storage medium; d) optionally, executing an animal detection model and analyzing the image data to determine a presence or an absence of an animal; e) optionally. transmitting the presence or the absence as data to one or more other algorithms, applications, processors, databases, or any combination thereof; e) executing an animal identification model and analyzing the image data to determine an identification of the animal; and f) associating the identification of the animal with other data before transmitting the identification to one or more storage mediums.

The present teachings relate to a method for automatically determining one or more conditions of an animal executed by one or more computing devices comprising: a) sensing one or more sensed conditions by one or more sensing devices and converting to one or more sensed data signals; b) transmitting the one or more incoming sensed data signals to a processor; c) converting the one or more sensed data signals to one or more sensed data by the processor and storing in a storage medium; e) executing an animal behavior model and analyzing the sensed data to determine one or more conditions of an animal, a pet health device, or both; and f) executing and/or preventing one or more operations of the pet health device, sending an alert to a user interface of an application, or any combination thereof.

The method for automatically determining one or more conditions of an animal may be used in combination with the method for animal detection and/or identification.

### DESCRIPTION OF DRAWINGS

FIG. 1 illustrates an architecture of a camera.

FIG. 2 illustrates an architecture of a controller.

FIG. 3 illustrates a pet profile database.

FIG. 4 illustrates a visual recognition database.

FIG. 5 illustrates a system with a network comprising a plurality of pet health devices.

FIG. 6 illustrates a system with a network comprising a plurality of pet health devices.

FIG. 7 illustrates a system configuration in a room.

FIG. 8 illustrates a system configuration in a room.

FIG. 9 illustrates a system configuration in a room.

FIG. 10 illustrates a sensing range of a pet health device.

FIG. 11 is a perspective view of a litter device.

FIG. 12 is a cross-section view of a litter device.

FIG. 13 is a front perspective view of a water dispenser.

FIG. 14 is a rear perspective view of a water dispenser.

FIG. 15 is a cross-section view of a water dispenser.

FIG. 16 is a front perspective view of a feeder.

FIG. 17 is a front perspective view of a feeder.

FIG. 18 is a front perspective view of a feeder.

FIG. 19 is a cross-section view of a feeder.

FIG. 20 is a front perspective view of a feeder.

FIG. 21 illustrates various user interfaces of a personal computing device.

FIG. 22 illustrates various notifications available via a user interface.

FIG. 23 is a flowchart illustrating animal detection via machine learning.

FIG. 24 is a flowchart illustrating animal identification via machine learning.

FIG. 25 is a flowchart illustrating animal behavior identification via machine learning.

FIG. 26 is a flowchart illustrating a video stream of an animal being captured.

### DETAILED DESCRIPTION

The explanations and illustrations presented herein are intended to acquaint others skilled in the art with the present teachings, its principles, and its practical application. The specific embodiments of the present teachings as set forth are not intended as being exhaustive or limiting of the present teachings. The scope of the present teachings should be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

### Pet Health Devices

The system of the present teachings may cooperate with and/or be integrated into one or more pet health devices. The one or more pet health devices may function to serve an animal with one or more needs necessary for their health. The needs may include water consumption, food consumption, waste elimination, movement, vital sign(s) monitoring, and/or the like. The one or more pet health devices may include one or more litter devices, feeders, water dispensers, wearables, embedded trackers, vital sign and/or biomarker detection devices, or any combination thereof. The one or more pet health devices may meet the needs of one or more domesticated animals. One or more domesticated animals may include one or more cats, rabbits, ferrets, pigs, dogs, ducks, goats, foxes, the like, or any combination thereof.

The one or more pet health devices may include one or more litter devices. The teachings may be particularly relevant to a litter device which is an automated litter device. An automated litter device may be any type of litter device which automates cleaning of the device after elimination of waste by an animal. A litter device may include the kind in which a chamber rotates to cause rotation of a sifting portion therein, which then segregates waste from litter. A litter device may be the kind in which a sifting portion rotates within a chamber to pass through the litter and segregate waste from the litter. A litter device may be the kind in which an automated sifting scoop passes through litter retained within a fairly rectangular litter box to sift and segregate waste from litter.

The litter device may include a bezel, a chamber, a box, a septum, a sifting scoop, a bonnet, a base, a waste receptacle, a track, a hub, an entry barrier, the like, or any combination thereof. The chamber may include an entry opening. The chamber may be configured to hold litter. The chamber may be configured to allow an animal to enter and/or exit. The chamber may be configured to allow an animal to excrete waste within the interior. The chamber may include a septum. The septum may include a sifting portion. The sifting portion may be configured for sifting through litter and separating waste from litter. The litter device may include a waste receptacle. A waste receptacle may be in communication with the chamber. A waste receptacle may be configured to receive waste. A waste receptacle may receive waste from the chamber. The waste receptacle may be configured as a waste drawer.

The present teachings may be useful for use with an automated litter device having a chamber supported by a base, having a waste drawer, or both. The teachings may also be useful for an automated litter device having an entry barrier which is able to block and allow access into a chamber. The chamber may be a portion of the device configured to hold litter, where an animal may enter and excrete waste, or both. The chamber may be supported by and/or rest above a base. The chamber may be rotatably supported by the base. The chamber may rotate through one or more cleaning cycles to allow for funneling and disposal of waste. The chamber may have an axis of rotation. The axis of rotation may extend through the entry opening of the chamber. The axis of rotation may be concentric or off-center with the entry opening. The axis of rotation may be a tilted axis of rotation. The tilted axis of rotation may promote funneling and disposal of waste, increased line of sight of one or more sensors, or both. The chamber may include a septum such that rotation of the chamber may result in rotation of a septum which sifts through the litter. The septum may filter clean litter from clumps of waste and guide funneling and/or disposal of the waste. Waste from the chamber may be disposed into a waste drawer. A waste drawer may be located in a support base of the device, below a chamber, adjacent to a chamber, or any combination thereof. A litter dispenser may be affixed to the litter device to replenish litter disposed during cleaning cycles. A bonnet may be located at least partially over a chamber to cover one or more components of the litter device, prevent access to one or more pinch points, or both. A chamber, bezel, cleaning cycle of the chamber, rotational capability, axis of rotation (e.g., tilted rotational axis) base (e.g., support base), bonnet, waste drawer, litter dispenser, and other components of the litter device may be configured such as those disclosed in U.S. Pat. Nos. 8,757,094; and 9,433,185; US Publication No: 2019/0364840; and PCT Patent Application No.: PCT/US2020/029776 (Published as PCT Publication No. WO 2020/219849A1), which are incorporated herein by reference in their entirety for all purposes.

The one or more pet health devices may include one or more feeders. The teachings may be particularly relevant to a feeder which is an automated feeder. The feeder may be any device that stores and dispenses food for consumption by an animal. Food may include any type of food suitable for consumption by an animal. Food may include solid food, semi-solid food, liquid, the like, or a combination thereof. Solid food may be in the form of granular material. Semi-solid food may be in the form of ground and/or shredded protein (e.g., meat) and/or vegetables and may be stored or served in a liquid (e.g., gravy). Liquid may refer to a water, broth, gravy, or other liquid. An automated feeder may dispense food into a serving bowl, present a container holding stored food therein, or both.

The present teachings may be useful with a feeder which stores food in granular form and dispenses a serving of the food into a feeding dish. The present teachings may be useful with a feeder including one or more of the following features: a housing, base portion, chamber portion, hopper, intermediate portion, feeding cavity, serving area, feeding dish, a chute, a cover, one or more handles, a control panel, a dispenser, one or more sensors, a sensing tower, drive source, a power source, or any combination thereof. The feeder may include a base portion, chamber portion supported by the base portion, and a dispenser. The chamber portion may include a hopper. The hopper may store the food therein. A sensing tower may extend through the hopper and housing one or more sensing devices. The sensing tower may extend from a bottom to a top of the hopper. One or more sensing devices may located at and/or toward a top and/or upper portion of the sensing tower. The sensing device(s) may have a line of sight down into the interior of the hopper. The sensing device(s) may be able to sense a presence, distance, and/or amount of food stored in the hopper. The feeder may have a front opposing a rear. The front of the feeder may be the side of the feeder in which a feeding cavity is exposed. The feeder may have a top opposing a bottom. The bottom of the feeder may be the portion of the feeder which rests on a surface during normal use of the feeder. A feeder may be an automated food dispenser such as disclosed in PCT Patent Publication No. WO 2020/061307, which is incorporated herein by reference in its entirety for all purposes. Another exemplary feeder may be the automated food dispenser such as disclosed in U.S. Pat. No. 9,161,514, which is incorporated herein by reference in its entirety for all purposes.

The present teachings may be useful with a feeder which stores food in semi-solid and/or liquid form within individual serving containers and presents an open container with the food therein. The feeder may include a container storage subassembly, container handling subassembly, container transport subassembly, container opening subassembly, a waste collection subassembly, a container disposal subassembly, the like, or a combination thereof. A container storage subassembly may allow for a plurality of food containers to be stored therein. The containers may be sealed to preserve the food therein. For example, the container storage subassembly may store one or more stacks of sealed containers. The container storage subassembly may include a hopper, magazine, or both. The container storage subassembly may substantially columnar. A container handling subassembly may function to retain a container while moving from a container storage subassembly toward a feeding area. A container handling subassembly may cooperate with a container transport subassembly. A container transport subassembly may function to move a container and/or container handling subassembly in one or more linear directions, away from a container storage subassembly, to a container opening position, to a feeding area, toward a waste collection subassembly, and/or the like. A transport subassembly may be coupled to the container handling subassembly such that one drive shaft (e.g., lead screw) is in rotatable communication with the container handling subassembly. Rotation of the drive shaft in a first direction may cause the container handling subassembly to move toward a front of the feeding assembly, a feeding arca, or both. Rotation of the drive shaft in a second direction may cause the container handling subassembly to move toward a rear of the feeding assembly, toward a loading position, or both. The container handling subassembly may move past a container opening subassembly. The container opening subassembly may be located above the container handling subassembly and/or container transport subassembly The container opening subassembly may include one or more jaws, hooks, and/or the like which engage with a lid of the container as the container passes. For example, a pair of jaws may grasp and pinch a leading edge of the lid. As the container continues to move forward on the container handling subassembly and moved by the container transport subassembly, the lid may be peeled away from the container base. The container transport subassembly continues to move the container handling subassembly and open container base to a feeding area (e.g., front of the feeder). The lid when removed, may fall into the waste collection subassembly. For example, a waste bin may be located below the container opening subassembly, container handling subassembly. and/or container transport subassembly. The open container may then be presented in a container display opening, allowing for an animal to consume the food stored therein. Once complete, the container and container handling subassembly may be retracted from the feeding area by the container transport subassembly. As the container handling subassembly is moved back toward the container storage subassembly, a container disposal subassembly may eject the container base into the waste collection subassembly. For example, a container disposal subassembly may apply a force onto the container base such that the container base is pushed off of the container handling subassembly and falls into the waste collection subassembly. Exemplary automated feeders may be the autonomous feeders as disclosed in U.S. Provisional Patent Application Nos. 63/341,962 and 63/599,131, and PCT Patent Publication No. WO 2023/220751 incorporated herein by reference in their entirety for all purposes.

The one or more pet health devices may include one or more water dispensers. The teachings may be relevant to a water dispenser which is an automated water dispenser. An automated water dispenser may be any type of dispenser which automated dispensing of water, or any other liquid, for consumption by an animal. An automated water dispenser may rely on any type of actuation mechanism for creating flow of water from a fresh water holding area toward a serving area. One or more actuation mechanisms may include one or more pumps, valves, carousels, drive units, the like, or any combination thereof.

The present disclosure may be useful with an automated liquid dispenser. The device may function to provide liquid suitable for consumption by an animal. Liquid may include water, semi-liquid food, and/or the like. The device may function in one or more modes. One or more modes may include a filling mode, circulating mode, emptying mode, or a combination thereof. The device may include a carousel, cap assembly, valve assembly, actuator assembly, one or more tanks (e.g., fresh tank, used tank), one or more housing portions (e.g., bottom, intermediate, and top), one or more serving bowls, one or more filters, the like, or a combination thereof. In general, a carousel may function like a water wheel to transfer liquid to one or more other areas of the device. The carousel may rotate to receive, circulate, and/or dispense fresh liquid; receive and/or dispense used liquid; or any combination thereof. Fresh water may be dispensed from a tank via one or more actuator assemblies, valve assemblies, or both. The one or more actuator assemblies may be engaged by rotation of the carousel in one or more directions. A direction of rotation of the carousel may be determined by the mode in which in the device is operating. A water dispenser may be an automated liquid dispensing device as disclosed in U.S. Provisional Patent Application No. 63/339,763 and PCT Patent Publication No. WO 2023/192540, which are incorporated herein by reference in their entirety for all purposes.

The one or more pet health devices may include one or more controllers. The one or more controllers may function to receive one or more signals, transmit one or more signals, control operations of one or more components of the devices, or a combination thereof. The one or more controllers may be in communication with and/or include one or more sensing devices, communication modules, networks, other controllers, other electrical components, or any combination thereof. The one or more controllers may be adapted to control operation of one or more electrical components of a pet health device. For example, signaling one or more drive sources (e.g., motors) to power on and causing rotation of a dispenser in a feeder to dispense food, causing rotation of chamber of a litter device to generate a cleaning cycle, causing rotation of a carousel in a water dispenser to dispenser water, and/or causing opening and/or closing of a lid to display and/or conceal food. The one or more controllers may automatically receive, interpret, and/or transmit one or more signals. The one or more controllers may be adapted to receive one or more signals from the one or more sensing devices. The one or more controllers may be in electrical communication with one or more sensing devices. The one or more controllers may interpret one or more signals from one or more sensing devices as one or more status signals. The controller may relay the one or more status signals to one or more other controllers, processors, storage mediums computing devices, and/or the like. The one or more controllers may be adapted to receive one or more signals from one or more computing devices. The one or more signals may include one or more instruction signals related to one or more instructions. The one or more instructions may be input by a user into a user interface, stored instructions on a computer readable medium (e.g., software) in one or more computing devices, and/or the like. The one or more controllers may automatically control one or more operations of one or more components upon receipt of one or more signals or instructions. The one or more controllers may reside within or be in communication with the one or more pet health devices. For example, in a litter device, the one or more controllers may be located within or affixed to a bezel, bonnet, base (e.g., support base), chamber, near an entry opening, the like, or any combination thereof. For example, in a feeder, the one or more controllers may be located within a base portion, intermediate portion, chamber portion, near a user interface, in a housing, in a container storage subassembly area, in proximity to a container opening subassembly, the like, or any combination thereof. For example, in a water dispenser, the one or more controllers may be located within the housing, above a feeding dish, in a base portion, near a drive source, the like, or any combination thereof. The one or more controllers may include one or more controllers, microcontrollers, microprocessors, processors, storage mediums, or a combination thereof. One or more suitable controllers may include one or more controllers, microprocessors, or both as described in U.S. Pat. Nos. 8,757,094; 9,433,185; 11,399,502, all of which are incorporated herein by reference in their entirety for all purposes. The one or more controllers may be in communication with and/or include one or more communication modules, processors, storage mediums, circuit boards (e.g., printed circuit board “PCB”), input and/or output peripherals, analog to digital convertors, the like, or any combination thereof.

The pet health devices may include one or more communication modules. The one or more communication modules may allow for the pet health device to receive and/or transmit one or more signals from one or more controllers and/or computing devices, be integrated into a network, or both. The one or more communication modules may have any configuration which may allow for one or more data signals from one or more controllers to be relayed to one or more other controllers, communication modules, communication hubs, networks, computing devices, processors, the like, or any combination thereof located external of the pet health device. The one or more communication modules may include one or more wired communication modules, wireless communication modules, or both. A wired communication module may be any module capable of transmitting and/or receiving one or more data signals via a wired connection. One or more wired communication modules may communicate via one or more networks via a direct, wired connection. A wired connection may include a local area network wired connection by an ethernet port. A wired communication module may include a PC Card, PCMCIA card, PCI card, the like, or any combination thereof. A wireless communication module may include any module capable of transmitting and/or receiving one or more data signals via a wireless connection. One or more wireless communication modules may communicate via one or more networks via a wireless connection. One or more wireless communication modules may include a Wi-Fi transmitter, a Bluetooth transmitter, an infrared transmitter, a radio frequency transmitter, an IEEE 802.15.4 compliant transmitter, cellular radio signal transmitter, Narrowband-Internet of Things (NB-IOT) transmitter, the like, or any combination thereof. A Wi-Fi transmitter may be any transmitter complaint with IEEE 802.11. A communication module may be single band, multi-band (e.g., dual band), or both. A communication module may operate at 2.4 Ghz, 5 Ghz, the like, or a combination thereof. A cellular radio signal transmitter may be any transceiver compatible with any cellular frequency band (e.g., 500, 900, 1,800, 1,900 MHZ) and/or network (3G, LTE, LTE Cat1, LTE M, 4G, 5G). A communication module may communicate with one or more other communication modules, computing devices, processors, or any combination thereof directly; via one or more communication hubs, networks, or both; via one or more interaction interfaces; or any combination thereof.

The pet health devices may have or be in communication with one or more sensing devices. The one or more sensing devices may function to sense the presence of an animal, a behavior of an animal, one or more traits of an animal, identify the animal, one or more conditions and/or operations of a pet health device, the like, or any combination thereof. The one or more sensing devices may receive one or more signals, transmit one or more signals, or a combination thereof. The one or more signals may be related to one or more conditions detected by the sensing device. The one or more conditions may be related to one or more operations of one or more components. The one or more sensing devices may cooperate with one or more other sensing devices which detect one or more conditions of one or more pet health devices, data related to an animal, or both. The one or more sensing devices may be located in any suitable location of a pet health device, affixed to the pet health device, in communication with a pet health device, distanced from a pet health device, the like, or any combination thereof. Based on the one or more conditions sensed, one or more sensing devices may transmit one or more signals to one or more controllers, processors, communication modules, computing devices, the like, or any combination thereof. One or more signals from one or more sensing devices may be converted into one or more signals (e.g., analog to digital, signal to a status signal), data entries, or both by one or more controllers, processors, communication modules, computing devices, or any combination thereof. One or more sensing devices may be configured to detect one or more conditions related to: visual traits of an animal; mass of an animal; touch, vibrations, capacitance, resistance, or the like related to physical contact by or proximity with an animal; identification of an animal (specifically or more generically): presence of an animal; biomarker(s) of an animal; vital sign(s) of an animal; the like; or any combination thereof.

The one or more sensing devices may include one or more cameras. The one or more cameras may be suitable for capturing one or more videos, images. frames, the like, or any combination thereof. The one or more cameras may be positioned within a setting to have a line of sight on one or more pet health devices, animals, or both. Line of sight may mean the camera is in view of at least part of or all of a front of a pet health device, a bowl (e.g., feeding dish, serving bowl) of a pet health device, through an entry opening, into the interior chamber of a pet health device, into a hopper or other storage area of a pet health device (e.g., line of sight onto transparent surface of hopper), an animal when using a pet health device, or any combination thereof. Line of sight may mean having an animal's body, side profile, front profile, rear profile, head, legs, eyes, nose, mouth, ears, tail or tail area, one or more bodily orifices, any combination thereof in view of the camera. The one or more cameras may have a line of sight (e.g., have in view) of a single pet health device, a portion of a device, or a plurality of pet health devices.

The one or more cameras may be suitable for capturing one or more key features of an animal for animal detection, identification, behavior, or any combination thereof. Key features are discussed hereinafter.

The one or more cameras may be suitable for capturing one or more features of one or more pet health devices for identifying the pet health device(s) in view. The one or more cameras may be suitable for capturing one or more features of a pet health device for detection, identification, condition and/or operation detection, or combination thereof. Identification may include identifying a specific type of pet health device (e.g., litter device, feeder, water dispenser, etc.), an exact pet health device (e.g., serial number), a location of a specific health device relative to another, an environment (e.g., setting) a pet health device is located in (e.g., bedroom, bathroom, laundry room), and/or the like. The one or more cameras may be suitable for capturing one or more conditions of a pet health device. One or more conditions may include cleanliness, litter level inside a chamber, position of a chamber, progress or status of a cleaning cycle, cleanliness in proximity to a pet health device (e.g., litter, waste, food, water on the floor), water level in a serving bowl, water level in a fresh tank, water level in a used tank, cleanliness of a serving bowl of a water dispenser and/or water in a serving bowl, level of food in a feeding dish, level of food in a hopper of a feeder, level of food in a container on display, number of containers in a container storage subassembly, cleanliness of a serving bowl and/or feeding area of a feeder and/or food in a serving bowl, the presence of pests, the presence of waste, the like, or any combination thereof. The camera may even capture an animal bringing an object to a pet health device which may then be recognized. Exemplary objects may include toys, other animals (e.g., mice, bird, rabbit), household goods, human wearables (e.g., socks, jewelry), and the like.

A camera may continuously, intermittently, or both capture incoming images (e.g., video stream, image stream). The camera may be continuously operational and capturing incoming images. The camera may be triggered to initiate and/or stop capturing incoming images via one or more other sensing devices. One or more sensing devices may sense a change in one or more conditions of one or more pet health devices, the presence and/or absence of an animal, the arrival of an animal, the departure of an animal, use of a pet health device by an animal, and/or the like. For example, an identification sensor may detect an identifier of an animal within a sensing range, transmit a status signal as a detection signal and/or identification signal to a controller, and the controller may then initiate the camera to begin capturing a video stream. As another example. one or more mass sensors may detect an animal incoming into a pet health device and/or approaching a pet health device, transmit the status signal as a detection signal and/or identification signal to a controller, the controller may then initiate the camera to begin capturing a video stream. Stopping of capturing the video stream may occur in similar manner. Such as by detecting the departure of the animal by the identification sensor and/or one or more mass sensors.

The one or more cameras may include one or more lenses, image sensors, processors, storage mediums, housings, lighting elements, the like, or any combination thereof.

The one or more cameras may have a wide-angle lens (e.g., viewing angle of 150 degrees or greater). The one or more cameras may be capable of capturing static images, video recordings, or both at resolutions of about 480 pixels or greater, 640 pixels or greater, 720 pixels or greater, or even 1080 pixels or greater. The one or more cameras may be able to capture video recordings at a frame rate of about 10 frames per second, 25 frames per second or greater, about 30 frames per second or greater, about 60 frames per second or greater, or even 90 frames per second or greater.

One or more cameras may include one or more image sensors. One or more image sensors may cooperate with a lens to react with incoming light through the lens. The one or more image sensors may convert the captured analog signals to digital signals. The one or more image sensors may then transmit the digital signals to one or more processors and/or storage mediums of the camera and/or pet health device.

The one or more cameras may be suitable for capturing images under one or more lighting conditions. Lighting conditions may include natural light, supplemental illumination, or both. Illumination may be visible, infrared, or both. Illumination may be provided by a lighting element. The lighting element may be part of the camera, part of the pet health device, or both. The lighting element may include one or more light emitting diodes (LEDs). For example, the lighting element may be positioned adjacent and/or near proximity to the lens of the camera. The lighting element may be above, below, and/or beside the lens.

The one or more cameras may cooperate with one or more other sensing devices, cameras, or both to determine distance, create 3D interpretations, or both. One or more cameras cooperating with other camera(s) or sensing device(s) may be able to determine a distance to an animal, a pet health device, components within a pet health device (e.g., litter, food, water), and/or the like. One or more cameras cooperating with other camera(s) or sensing device(s) may be able to collect data to generate substantially accurate three-dimensional interpretations of an animal, a pet health device, components of a pet health device, an environment, other items within the surrounding environment, the like, or a combination thereof. Cameras may cooperate together for object detection, similarity matching, and/or depth estimation such as described in “Multi-Camera 3D Mapping with Object Detection, Similarity Matching and Depth Estimation” (2021) by Emilio Montoya, David Ramirez, and Dr. Andreas Spanias, incorporated herein by reference in its entirety.

One suitable camera for use may include the SainSmart IMX 219 Camera Module with an 8MP sensor and 160-degree field of vision, the camera module and its specifications incorporated herein by reference in its entirety for all purposes.

The one or more cameras may include a camera as disclosed in U.S. Provisional Application No. 63/490,910, incorporated herein by reference in its entirety.

The one or more sensing devices may include one or more mass sensors. The one or more mass sensors may function to monitor a mass of a device or a portion of a device, monitor a mass of an animal, identify a presence of an animal within or near a device, or any combination thereof. A mass sensor may continuously, intermittently, or both monitor for mass and/or changes thereof. The mass sensor may be located at any location in or near a pet health device so that any change in mass of the device, presence of an animal within or near the device, or any combination thereof may be detected. The mass sensor may include one or more load cells, resistors, force sensors, switches, controllers, microprocessors, the like, or a combination thereof. Exemplary mass sensors and configurations may be as described in U.S. Pat. Nos. 8,757,094, 9,422,185, 11,399,502, and 11,523,586; and U.S. Provisional Patent Application No. 63/325,480, all of which are incorporated herein by reference in their entirety. The one or more mass sensors may be located anywhere within, on, and/or near a pet health device suitable for detecting mass of an animal, the device or portions thereof, or both. The one or more mass sensors may be located within one or more feet and/or legs of one or more pet health devices, as a scale plate integrated into a bottom of a pet health device, within an interior of one or more pet health devices, on a mat or scale below and/or near (e.g., in front of) one or more pet health devices, the like, or any combination thereof. Exemplary integration into a litter device may include within one or more feet, between a chamber and a support base, below and/or integrated into a waste drawer, a scale/mat below the litter device, the like, or any combination thereof. Exemplary integration with a feeder may include below a serving bowl, one or more feet/legs/scale plates of the feeder, a scale/mat below the feeder, a scale/mat located in front of a serving bowl, the like, or any combination thereof. Exemplary integration with a liquid dispenser may include below a serving bowl, in one or more feet/legs/scale plate of the dispenser, a scale/at below the dispenser, a scale/mat located in front of a serving bowl, the like, or any combination thereof. The one or more mass sensors may be in communication with one or more controllers, computing devices, processors, communication modules, the like, or any combination thereof. The one or more mass sensors may be directly and/or indirectly connected to one or more controllers, computing devices, processors, communication modules, or any combination thereof. The one or more mass sensors may relay one or more signals relating to a monitored mass to one or more controllers, computing devices, processors, communication modules, or any combination thereof. The one or more mass sensors may relay a presence of mass above a predetermined mass, a real-time mass, a change in mass, or a combination thereof to one or more controllers, computing devices, processors, communication modules, or any combination thereof. A signal from one or more mass sensors relayed to one or more controllers, computing devices, processors, communication modules, or any combination thereof related to the detected mass may be referred to as a mass signal. The mass signal may be included as a status signal.

The one or more sensing devices may include one or more temperature sensors. The one or more temperature sensors may function to monitor a temperature of a device, monitor a temperature of an animal, identify a presence of an animal within or near a device, identify abnormal temperature of an animal or ambient environment, or any combination thereof. A temperature sensor may continuously, intermittently, or both monitor for temperature and/or changes thereof. The temperature sensor may be located at any location in or near a pet health device so that any change in temperature of the device or ambient environment, presence of an animal within or near the device, temperature of the animal, or any combination thereof may be detected. The temperature sensor may be touchless such as to detect temperature from a distance without requiring direct contact. One or more temperature sensors may include one or more infrared thermometers, thermistors (e.g., digital thermometer), the like, or any combination thereof. The one or more temperature sensors may be located anywhere within, on, and/or near a pet health device suitable for detecting temperature of an animal, the device or portions thereof, an ambient environment, or any combination thereof. The one or more temperature sensors may be located within an interior or exterior of one or more pet health devices. Exemplary integration into a litter device may include affixed to a bezel, within a chamber, affixed to a bonnet, the like, or any combination thereof. Exemplary integration to a feeder or liquid dispenser may include at or near a feeding area (e.g., serving bowl), a front face of the device, or both. The one or more temperature sensors may be in communication with one or more controllers, computing devices, processors, communication modules, or any combination thereof. The one or more temperature sensors may be directly and/or indirectly connected to one or more controllers, computing devices, processors, communication modules, or any combination thereof. The one or more temperature sensors may relay one or more signals related to a monitored temperature to one or more controllers, computing devices, processors, communication modules, or any combination thereof. The one or more temperature sensors may relay a presence of temperature above a predetermined temperature, a real-time temperature, a change in temperature, or a combination thereof to one or more controllers, computing devices, processors, communication modules, or any combination thereof. A signal from one or more temperature sensors relayed to one or more controllers, computing devices, processors, communication modules, or any combination thereof related to the detected temperature may be referred to as a temperature signal. The temperature signal may be included as a status signal.

The one or more sensing devices may include one or more laser sensors. The one or more laser sensors may detect a presence of an animal at, in, and/or near a pet health device; movement of an animal relative to a device; size of an animal; distance to an animal; a presence, amount, and/or distance of food in a pet health device; the like; or any combination thereof. The one or more laser sensors may be located anywhere on, within, or near a pet health device. One or more laser sensors may include one or more time-of-flight sensors, infrared sensors, ultrasonic sensors, membrane sensors, radio frequency (RF) admittance sensors, optical interface sensors, microwave sensors, the like, or combination thereof. The one or more laser sensors may be located anywhere within, on, and/or near a pet health device suitable for detecting presence, distance, or other physical traits of an animal. The one or more laser sensors may be located within an interior and/or exterior of one or more pet health devices. Exemplary integration into a litter device may include affixed to a bezel, within a chamber. inside of a waste receptacle, affixed to a bonnet, the like, or any combination thereof. Exemplary integration to a feeder or liquid dispenser may include at or near a serving dish, inside of a hopper and/or tank, part of a sensing tower, a front face of the device, or any combination thereof. The one or more laser sensors may be in communication with one or more controllers, computing devices, processors, communication modules, or any combination thereof. The one or more laser sensors may be directly and/or indirectly connected to one or more controllers, computing devices, processors, communication modules, or any combination thereof. The one or more laser sensors may relay one or more signals related to a monitored physical condition to one or more controllers, computing devices, processors, communication modules, or any combination thereof. The one or more laser sensors may relay a presence of an animal, an absence of an animal, a distance to an animal, one or more positions or behavior of an animal, the like, or a combination thereof to one or more controllers, computing devices, processors, communication modules, or any combination thereof. One or more laser sensors may cooperate together to determine and/or track one or more positions or physical behaviors of an animal. Suitable exemplary laser sensors and configurations are disclosed in U.S. Pat. Nos. 11,399,502, and 11,523,586, which are incorporated herein by reference in their entirety. A signal from one or more laser sensors relayed to one or more controllers, computing devices, processors, communication modules, or any combination thereof related to the detected object may be referred to as a laser signal. The laser signal may be included as a status signal.

The laser sensor(s) may collect sufficient data to create three-dimensional representations of an animal, identifying characteristics of an animal, or both. One or more processors may generate the three-dimensional representations based on the data received from the laser sensor(s). The three-dimensional representations may be used to determine behaviors of an animal, such as the acts of sleeping, sitting, squatting, defecating, urinating, self-grooming, the like, or any combination thereof. A signal from one or more laser sensors relayed to one or more controllers, computing devices, processors, communication modules, or any combination thereof related to the detected presence may be referred to as a presence signal.

The one or more sensing devices may include one or more identification sensors (“ID sensor”). One or more ID sensors may function to identify an animal by its identity via one or more identifiers on an animal. An identification sensor may be one or more readers configured to communicate with one or more identifiers. An identification sensor may include a radio frequency identification (RFID) reader, Bluetooth reader, a Near Field Communication (NFC) reader, the like, or any combination thereof. The one or more identification sensors may receive identification of an animal by collecting identifying data directly from the identifier, from receiving a signal related to identification data in an identification database, or both. The one or more identification sensors may be located anywhere within, on, and/or near a pet health device suitable for communicating with the identifier when an animal is near, at, or in the pet health device. The one or more identification sensors may be located within an interior or exterior of one or more pet health devices. Exemplary integration into a litter device may include affixed to a bezel, within a chamber, affixed to a bonnet, the like, or any combination thereof. Exemplary integration to a feeder or liquid dispenser may include at or near a serving dish, a front face of the device, or both. The one or more identification sensors may be in communication with one or more controllers, computing devices, processors, communication modules, or any combination thereof. The one or more identification sensors may be directly and/or indirectly connected to one or more controllers, computing devices, processors, communication modules, or any combination thereof. The one or more identification sensors may relay one or more signals related an identifier to one or more controllers, computing devices, processors, communication modules, or any combination thereof. The one or more identification sensors may relay identifying data of an animal, data related to a subsequent database to retrieve identifying data of an animal, or both. A signal from one or more identification sensors relayed to one or more controllers, computing devices, processors, communication modules, or any combination thereof related to the detected identifier may be referred to as an identification signal. The identification signal may be included as a status signal.

An animal may be associated with an identifier. An identifier may function to specifically identify an animal. An identifier may be worn on a collar, embedded within the flesh (e.g., microchip), or the like. Exemplary identifiers may include radio frequency identification (RFID) tags, Bluetooth tags, Near Field Communication (NFC) tags, passive IR, the like, or any combination thereof. One or more identifiers may have identification information stored therein, link to one or more databases which have identification information stored therein, or both. One or more identifiers may be active or passive. Passive may mean that the identifier is free of its own internal power source. Active may mean that the identifier is powered and/or broadcasts its own signal. An identifier may establish a signal with an identification sensor. This signal may be referred to as an identifier signal. An identifier signal may also be included as a status signal.

Suitable exemplary identification sensor and identifiers are disclosed in PCT Publication No. PCT/US2021/056490 and U.S. Provisional Patent Application No. 63/625,515, which are incorporated herein by reference in their entirety for all purposes.

The one or more sensing devices may include one or more touch sensors. The one or more touch sensors may detect presence of an animal, consumption or use by an animal, or both. The one or more touch sensors may be located anywhere on, within, or near a pet health device. One or more touch sensors may include one or more tactile sensors (e.g., similar to fingertip force sensor), capacitive sensors (e.g., capacitive touch sensor), resistive sensors (e.g., resistive touch sensor), pressure sensors, vibration sensors (e.g., Piezo vibration sensor), the like, or any combination thereof. The one or more touch sensors may be located anywhere within, on, and/or near a pet health device suitable for detecting presence, absence, use, or consumption by an animal. The one or more touch sensors may be located within an interior or exterior of one or more pet health devices. Exemplary integration into a litter device may include affixed to a step, bezel, within a chamber, affixed to a support base, below a chamber, affixed to a bonnet, the like, or any combination thereof. Exemplary integration to a feeder or liquid dispenser may include at or near a serving dish, integrated into a mat below and/or in front of the feeder or liquid dispenser, or combination thereof. The one or more touch sensors may be in communication with one or more controllers, computing devices, processors, communication modules, or any combination thereof. The one or more touch sensors may be directly and/or indirectly connected to one or more controllers, computing devices, processors, communication modules, or any combination thereof. The one or more touch sensors may relay one or more signals related to sensing the physical touch of an animal on one or more components of a pet health device to one or more controllers, computing devices, processors, communication modules, or any combination thereof. The one or more touch sensors may relay the sensed touch to one or more controllers, computing devices, processors, communication modules, or any combination thereof. A signal from one or more touch sensors relayed to one or more controllers, computing devices, processors, communication modules, or any combination thereof related to the detected presence may be referred to as a touch signal. A touch signal may also be included as a status signal.

The one or more sensing devices may include one or more animal behavior sensors. The one or more animal behavior sensors may function to collect data relative to an animal's behavior away or at one or more pet health devices, and/or in or even away from the household. An animal behavior sensor may be able to sense motion, location, sound, vital conditions, physiological conditions, the act of eating or drinking, environmental surroundings, and/or the like. An animal behavior sensor may even aid in determining habits of an animal while inside of a household as compared to when outside the household (e.g., free-roaming cat, dog allowed outdoors in a fenced in yard, etc.). An animal behavior sensor may include one or more motion sensors, location sensors, sound sensors, vital sign sensors, physiological sign sensors, the like, or any combination thereof. One or more motion sensors may be able to measure acceleration, orientation, velocity (angular velocity), magnetic fields, the like, or any combination thereof. One or more motion sensors may include one or more accelerometers, gyroscopes, magnetometers, altimeters, inertial measurement units, the like, or any combination thereof. The one or more location sensors may be able to detect a current location of an animal, past location(s) of an animal, aid in creating mapping of an animal's movement patterns, and/or the like. A location sensor may include one or more global positioning system (GPS) sensors, other satellite navigation sensors, inertial measuring units, ultra-wideband (UWB) sensors/transceivers the like, or any combination thereof. A sound sensing device may function to pick up sound emitted from an animal, an ambient environment, or both. A sound sensing device may include one or more microphones. A vital sign sensor may be able to detect vital signs including heart rate, blood oxygen level, body temperature, respiratory rate, being awake or asleep, the like, or any combination thereof. The one or more vital sign sensors may include one or more optical heart rate sensors, pulse oximeters, blood oxygen (SpO2) sensors, bioimpedance sensors, electrocardiogram (ECG) sensors, skin temperature sensors, piezoelectric sensor (i.e., for sensing heart rate), the like, or any combination thereof. The one or more animal behavior sensors may be worn by the animal, embedded into the animal under the skin (e.g., similar to a microchip), part of a mat or other surface in proximity to an animal, into a pet health device, or any combination thereof. The one or more animal behavior sensors may be integrated into a collar, or other animal wearable. The one or more animal behavior sensors may be used for determining the location of waste expelled from an animal (e.g., finding fecal matter in a yard for subsequent removal). The one or more animal behavior sensors may even be used to mapping property based on the motion of the animal.

The one or more sensing devices may include one or more air sensors. The one or more air sensors may function to detect if waste has been eliminated by an animal, a type of waste eliminated by an animal, or both. The one or more air sensors may sense one or more gasses or compounds emitted from animal waste. The one or more air sensors may sense one or more gasses compounds, or both associated with urine, fecal matter, or both. The one or more air sensors may be integrated into a pet health device, onto an animal wearable, or both. The one or more air sensors may include one or more volatile organic compound (VOC) sensors. Exemplary air sensors may include: Bosch Sensortec BME680 gas sensor, Figaro USA, Inc. TGS2600 air quality sensor, Winsen semiconductor combustible gas sensor MQ-4B, and Winsen Meu-H2S hydrogen sulfide gas sensor, all of which are incorporated herein by reference in their entirety for all purposes. For example, one or more air sensors may be integrated onto a bezel, a bonnet, into a chamber. or combination thereof of a litter device. For example, one or more air sensors may be located with one or more other sensors on an upper portion of a bezel.

The pet health devices may be integrated into a system. The system may allow for monitoring signals from, receiving signals from, and/or sending signals to one or more of the pet health devices. The system may allow for sending one or more instruction signals to a pet health device. The system may allow for transmitting one or more signals, status signals, or both from the pet health device. The system may allow for storing one or more data entries related to one or more signals. The system may allow for one or more algorithms to be executed remote from the pet health devices. The system may allow for controlling of one or more operations of the pet health devices while remote from the device. The system may allow for a plurality of health devices to work together. The system may include one or more pet health devices, one or more communication hubs, computing devices, processors, storage mediums, databases, the like, or any combination thereof.

The one or more pet health devices may be in communication with a communication hub. A communication hub may function to receive one or more signals, transfer one or more signals, or both from one or more pet health devices, sensing devices, communication modules, controllers, processors, computing devices, the like, or any combination thereof. The communication hub may be any type of communication hub capable of sending and transmitting data signals over a network to one or a plurality of computing devices, compatible with one or more communication modules, or both. The communication hub may connect to one or more components of the system via their respective communication modules. The communication hub may include a wired router, a wireless router, an antenna, a satellite, or any combination thereof. For example, an antenna may include a cellular tower. The communication hub may be connected to the one or more pet health devices, sensing devices (e.g., camera), one or more computing devices, or any combination thereof via wired connection, wireless connection, or a combination of both. For example, the communication hub may be in wireless connection with the pet health devices via the communication module. The communication hub may allow for communication of a computing device with the pet health devices when the computing device is directly connected to the communication hub, indirectly connected to the communication hub, or both. A direct connection to the communication hub may mean that the computing device is directly connected to the communication hub via a wired and/or wireless connection and communicates with the litter device through the communication hub. An indirect connection to the communication hub may mean that a computing device first communicates with one or more other computing devices via a network before transmitting and/or receive one or more signals to and/or from the communication hub and then to the litter device.

The one or more pet health devices may be integrated into one or more networks. The pet health devices may be in removable communication with one or more networks. The one or more networks may be formed by placing the pet health devices in communication with one or more other computing devices. One or more networks may include one or more communication hubs, communication modules, computing devices, controllers, the like, or a combination thereof as part of the network. One or more networks may be free of one or more communication hubs. One or more computing devices of the system may be directly connected to one another without the use of a communication hub. For example, a communication module of a pet health device may be placed in direct communication with a communication module of a mobile communication device (e.g., mobile phone) without having a communication hub therebetween. The pet health devices connected together without a communication hub may form a network, and/or be connected to another network. As another alternative, one or more pet health devices may include a communication hub integrated therein. One or more pet health devices form a network by connecting to the same communication hub of one of the pet health devices and/or be connected to another network. One or more networks may be connected to one or more other networks. One or more networks may include one or more local area networks (LAN), wide area networks (WAN), intranet, Internet, Internet of Things (IOT), the like, or any combination thereof. The network may allow for the pet health devices to be in communication with one or more user interfaces remote from the device via the Internet, such as through one or more managed cloud-computing services, edge-computing services, or both. An exemplary managed cloud service may include AWS IoT Core by Amazon Web Services®). An exemplary edge computing service may include FreeRTOS® provided by Amazon Web Services®. It is possible various networks and computing services may cooperate with one another (e.g., combination of edge computing and cloud computing). The network may be temporarily, semi-permanently, or permanently connected to one or more computing devices, pet health devices, or both. A network may allow for one or more computing devices to be temporarily and/or permanently connected to the pet health devices to transmit one or more data signals to the pet health devices, receive one or more data signals from the devices, or both. The network may allow for one or more signals from one or more controllers to be relayed through the system to one or more other computing devices, processors, storage mediums, the like, or any combination thereof. The network may allow for one or more computing devices to receive one or more data entries from and/or transmit one or more data entries to one or more storage mediums. The network may allow for transmission of one or more signals, status signals, data entries, instruction signals, or any combination thereof for processing by one or more processors.

Devices on the network may communicate via one or more protocols. The one or more protocols may allow for two or more devices part of the network or system to communicate with one another either while in direct or indirect communication, wireless or wired communication, via one or more communication hubs, via one or more communication modules, the like, or any combination thereof. The one or more protocols may be any protocol suitable for use in telecommunications. The one or more protocols may be suitable for wired, wireless, or both communication styles between devices within the network or system. The one or more protocols may allow the devices of the system to be connected to and communication with one another through the Internet. The network and protocols may allow for the devices to be an “Internet of Things” (IoT). The one or more protocols may be those compatible with cloud computing services, edge computing services, or both. Exemplary cloud and edge computing services may include Amazon Web Services®, Microsoft Azure®), Google Cloud®), IBM®, Oracle Cloud®), the like, or any combination thereof. One or more cloud computing services may be managed by one or more managed cloud services. Exemplary protocols may include simple object access protocol (SOAP), hypertext transfer protocol (HTTP), user datagram protocol (UDP), message queuing telemetry transport (MQTT), Bluetooth low energy (BLE) protocol, IEEE 802 family of standards, the like, or any combination thereof. For example, a pet health device may connect wirelessly to a computing device using one or more protocols. Exemplary protocols may include UDP, BLE, and the like which allow for direct communication between devices. UDP and BLE may even be useful for allowing direct communication with devices without using the Internet as part of the network. As another example, a pet health device may connect with a dispatch interface, interaction interface, or both via one or more protocols using the Internet. Exemplary protocols for communication from the litter device to a dispatch interface, interaction interface, or both may include UDP, MQTT, REST, and the like. As another example, a dispatch interface, interaction interface, or both may communicate with an authentication portal using one or more protocols either directly or indirectly through the Internet. Exemplary protocols for communication between a dispatch interface or interaction interface and an authentical portal may include REST, SOAP, MQTT, the like. or any combination thereof. Suitable protocols useful as IoT protocols may be those provided by “IoT Standards and Protocols” by Postscapes™ available at https://www.postscapes.com/internet-of-things-protocols/, incorporated herein by reference in its entirety for all purposes.

The pet health devices may include and/or be in communication with one or more computing devices. The one or more computing devices may function to receive and/or transmit one or more signals, convert one or more signals to data entries, to send one or more data entries to a storage medium, to store one or more data entries, to retrieve one or more data entries from a storage medium, to compute and/or execute one or more algorithms and/or models, the like, or any combination thereof. One or more computing devices may include or be in communication with one or more other computing devices, processors, storage mediums, databases, interaction devices, pet health device(s), or any combination thereof. One or more computing devices may communicate with one or more computing devices, processors, storage mediums, databases, or any combination thereof through an interaction interface, dispatch interface, or both. Communication between computing devices may be controlled or managed via a managed cloud service, edge service, or both. The one or more computing devices may include one or more non-transitory storage mediums. A non-transitory storage medium may include one or more physical servers, virtual servers, or a combination of both. One or more servers may include one or more local servers, remote servers, or both. One or more computing devices may include one or more controllers (e.g., including processor) of pet health device(s), one or more processors of sensing devices (e.g., including image processor), personal computing devices, or both. One or more personal computing devices may include one or more personal computers (e.g., laptop, desktop, etc.), one or more mobile computing devices (e.g., tablet, mobile phone, etc.), or both. One or more computing devices may use one or more processors.

One or more computing devices may include one or more processors. The one or more processors may function to analyze one or more signals from the pet health device(s), one or more sensing devices, one or more storage mediums, databases, communication modules, the like, or any combination thereof. The one or more processors may be located within or in communication with one or more computing devices, servers, storage mediums, or any combination thereof. One or more processors may be in communication with one or more other processors. The one or more processors may function to process data, execute one or more algorithms to analyze data, execute one or more algorithms to execute one or more operations of one or more pet health devices and/or generate one or more notifications, evaluate data against one or more rules, models, other data, the like, or any combination thereof. The one or more processors may automatically process data, execute one or more algorithms, evaluate data, or a combination thereof; may wait for an instruction or signal such as from a user; or any combination thereof. Processing data may include receiving, transforming, outputting, executing, the like, or any combination thereof. One or more processors may be part of one or more hardware, software, systems, or any combination thereof. One or more hardware processors may include one or more central processing units, multi-core processors, front-end processors, image processing units, the like, or any combination thereof. One or more software processors may include one or more word processors, document processors, the like, or any combination thereof. One or more system processors may include one or more information processors, the like, or a combination thereof. One or more processors suitable for use within the pet health device(s) as part of the one or more controllers may include a microcontroller, such as Part No. PIC18F45K22 and/or Part No. PIC18F46J50 produced by Microchip Technology Inc., incorporated herein by reference in their entirety for all purposes. The one or more processors may be located within a same or different non-transitory storage medium as one or more storage mediums, other processors, communication modules, communication hubs, or any combination thereof. The one or more processors may be an ARM-based processor. Exemplary ARM-based processors may include one or more of the Cortex-M Family, versions ARM to ARMv6 (ARM 32-bit), version ARMv6-M to ARMv9-R (ARM 32-bit Cortex), versions ARMv8-A to ARMv-9 (ARM 64/32-bit), the like, or any combination thereof. The one or more processors may include one or more image processors, artificial intelligence processors video processors, the like, or a combination thereof. An exemplary artificial intelligence processor may include the Ingenic T31 video processor, which is incorporated herein by reference for all purposes. The one or more processors may include one or more cloud-based processors. A cloud-based processor may be part of or in communication with a dispatch interface, an interaction interface, an authentication portal, or a combination thereof. A cloud-based processor may be located remote from a pet health device, a computing device, one or more other processors, one or more databases, or any combination thereof. Cloud-based may mean that the one or more processors may reside in a non-transitory storage medium located remote from the pet health device, computing device, processor, databases, or any combination thereof. One or more cloud-based processors may be accessible via one or more networks. A suitable cloud-based processor may be Amazon Elastic Compute Cloud™ (EC2™) may be provided by Amazon Web Services®), incorporated herein by reference in its entirety for all purposes. Another suitable platform for a cloud-based processor may include Lambda™ provided by Amazon Web Services®, incorporated herein in its entirety by reference for all purposes. The one or more processors may convert data signals to data entries to be saved within one or more storage mediums. The one or more processors may access one or more algorithms to analyze one or more data entries and/or data signals. The one or more processors may access one or more algorithms to generate one or more operations of one or more pet health devices, generate one or more notifications to an application, or both. The one or more processors may access one or more algorithms saved within one or more storage mediums. The one or more algorithms being accessed by one or more processors may be located in a same or different storage medium or server as the processor(s).

One or more computing devices may include one or more storage mediums (“memory storage medium”). The one or more storage mediums may include one or more hard drives (e.g., hard drive memory), chips (e.g., Random Access Memory “RAM)”), discs, flash drives, memory cards, the like, or any combination thereof. The one or more storage mediums may include one or more cloud-based storage mediums. A cloud-based storage medium may be located remote from a pet health device(s), a sensing device, a computing device, one or more processors, one or more databases, or any combination thereof. Cloud-based may mean that the one or more storage mediums may reside in a non-transitory storage medium located remote from the pet health devices, computing device, processor, other databases, or any combination thereof. One or more cloud-based storage mediums may be accessible via one or more networks. A suitable cloud-based storage medium may be Amazon S3™ provided by Amazon Web Services®), incorporated herein by reference in its entirety for all purposes. One or more storage mediums may store one or more data entries in a native format, foreign format, or both. One or more storage mediums may store data entries as objects, images, files, blocks, or a combination thereof. The one or more storage mediums may include one or more algorithms, models, rules, databases, data entries, the like, or any combination therefore stored therein. The one or more storage mediums may store data in the form of one or more databases.

One or more computing devices may include one or more databases. The one or more databases may function to receive, store, and/or allow for retrieval of one or more data entries. The one or more databases may be located within one or more storage mediums. The one or more databases may include any type of database able to store digital information. The digital information may be stored within one or more databases in any suitable form using any suitable database management system (DBMS). Exemplary storage forms include relational databases (e.g., SQL database, row-oriented, column-oriented), non-relational databases (e.g., NoSQL database), correlation databases, ordered/unordered flat files, structured files, the like, or any combination thereof. The one or more databases may store one or more classifications of data models. The one or more classifications may include column (e.g., wide column), document, key-value (e.g., key-value cache, key-value store), object, graph, multi-model, or any combination thereof. One or more databases may be located within or be part of hardware, software, or both. One or more databases may be stored on a same or different hardware and/or software as one or more other databases. The databases may be located within one or more non-transitory storage mediums. One or more databases may be located in a same or different non-transitory storage medium as one or more other databases. The one or more databases may be accessible by one or more processors to retrieve data entries for analysis via one or more algorithms. The one or more databases may be one or more cloud-based databases. Cloud-based may mean that the one or more databases may reside in a non-transitory storage medium located remote from the pet health device(s). One or more cloud-based databases may be accessible via one or more networks. One or more databases may include one or more databases capable of storing one or more conditions of pet health device(s), one or more status signals related to pet health device(s), one or more instruction signals sent to pet health device(s), one or more users, one or more user accounts, one or more registered pet health device(s), one or more traits and/or characteristics of one or more animals, one or more identifications of one or more animals, the like, or any combination thereof. The one or more databases may include one or more pet profile databases, visual recognition databases, user databases, user settings databases, commands databases, activities databases, behavior databases, device databases, lifetime cycles databases, user computing device databases, registered device databases, training databases, the like, or a combination thereof. One suitable database service may be Amazon DynamoDB® offered through Amazon Web Services®, incorporated herein in its entirety by reference for all purposes. One or more databases may include or be similar to those disclosed in U.S. Pat. No. 11,399,502 which is incorporated herein by reference in its entirety for all purposes. One or more databases and their properties may be discussed relative to one or more methods of the present teachings.

One or more computing devices may include one or more interaction interfaces. One or more interaction devices may function to transmit and/or relay one or more signals, data entries, or both from one or more computing devices, processors, storage mediums, databases, or a combination thereof to one or more other computing devices, processors, storage mediums, databases, or a combination thereof. One or more interaction interfaces may include one or more application programming interfaces (API). The one or more interaction interfaces may utilize one or more architectures. The one or more architectures of an interaction interface may be one or more web service architectures useful for requesting, receiving and/or transmitting one or more data signals, data entries, or both from one or more other remotely located computing devices connected via one or more networks (e.g., web-based resources). One or more web service architectures may include Representation State Transfer (REST), gRPC, the like, or any combination thereof. One suitable interaction interface which is a REST API may be Amazon API Gateway IM provided by Amazon Web Services®, incorporated herein by reference in its entirety for all purposes. The one or more interaction interfaces may utilize one or more protocols for transmitting and/or receiving one or more data signals, data entries, or both. One or more protocols may include simple object access protocol (SOAP), hypertext transfer protocol (HTTP), user datagram protocol (UDP), message queuing telemetry transport (MQTT), the like, or any combination thereof.

The system in which the pet health device(s) may be integrated into may include and/or be connected to one or more authentication controls. One or more authentication controls may function to control access of a user to one or more pet health devices, computing devices, processors, storage mediums, databases. interaction interfaces, e-commerce platforms, the like, or any combination thereof. The one or more authentication controls may be in communication with one or more components of the system via one or more networks. The one or more authentication controls may communicate with one or more other components of the system via one or more interaction interfaces. The one or more authentication controls may receive one or more user credentials via one or more user interfaces of one or more computing devices. One or more user credentials may include one or more data entries related to one or more user accounts. One or more user credentials may include one or more user login identifications (e.g., “user ID”), passwords, the like, or a combination thereof. One or more authentication controls may include one or more authentication algorithms. The one or more authentication algorithms may compare the one or more user credentials provided via a user interface with one or more data entries residing within one or more databases, such as a User Database and/or User Settings Database. If the one or more user credentials match one or more data entries, the one or more authentication algorithms may instruct one or more computing devices, processors, or both to allow a user to access one or more data entries, receive one or more data signals, transmit one or more instruction signals, or any combination thereof. A suitable authentication control may include Amazon Cognito™ available through Amazon Web Services®, incorporated herein by reference in its entirety for all purposes. One or more authentication controls may cooperate with one or more e-commerce platforms. One or more authentication controls may authenticate one or more users based on one or more user credentials received from one or more e-commerce platforms, stored within one or more databases of one or more e-commerce platforms, or both.

One or more computing devices may include one or more user interfaces. The one or more user interfaces may function to display information related to one or more pet health devices, display one or more notifications related to one or more animals, receive user inputs related to the pet health devices, transmit information related to the pet health devices, or any combination thereof. The one or more user interfaces may be located on the pet health device, a separate computing device, or both. One or more user interfaces may be part of one or more computing devices. One or more user interfaces may include one or more interfaces capable of relaying information (e.g., data entries) to a user, receiving information (e.g., data signals) from a user, or both. One or more user interfaces may display information related to the pet health device. One or more user interfaces may display information from one or more algorithms. The user interface may allow for inputting of information related to a pet health device. Information may include a username, password, one or more instruction signals, uploaded documents (e.g., veterinary documents), the like, or any combination thereof. The one or more user interfaces may include one or more graphic user interfaces (GUI). The one or more graphic interfaces may include one or more screens. The one or more screens may be a screen located directly on the pet health device, another computing device, or both. The one or more screens may be a screen on a personal computing device (e.g., mobile computing device, personal computer). The one or more graphic interfaces may include and/or be in communication with one or more user input devices. The one or more user input devices may allow for receiving one or more inputs (e.g., instruction signals) from a user. The one or more input devices may include one or more buttons, wheels, keyboards, switches, touchscreens, the like, or any combination thereof. The one or more input devices may be integrated with a graphic interface. The one or more input devices may include one or more touch-sensitive monitor screens.

The system may include or be in communication with one or more applications. The application (i.e., “computer program”) may function to access data, upload data, receive data, receive instructions, transmit instructions, display information, transmit notifications, the like, or a combination thereof relative to one or more pet health devices, an animal, a computing device, the like, or any combination thereof. The application may be stored on one or more storage mediums. The application may be stored on one or more personal computing devices, remote computing devices, or both. The application may be accessible by one or more personal computing devices while being executed from one or more remote computing devices. The application may comprise and/or access one or more computer-executable instructions, algorithms, rules, models, processes, methods, user interfaces, menus, databases, the like, or any combination thereof. The computer-executable instructions, when executed by a computing device may cause the computing device to perform one or more methods described herein. The application may be downloaded, accessible without downloading, or both. The application may be downloadable onto one or more computing devices. The application may be downloadable from an application store (i.e., “app store”). An application store may include, but is not limited to, Apple® App Store®), Google Play®, Amazon Appstore®, Skills Shop for Amazon's® Alexa®, the like, or any combination thereof. The application may be accessible without downloading onto one or more computing devices. The application may be accessible via one or more web browsers. The application may be accessible as a website. The application may interact and/or communicate through one or more user interfaces. The application may be utilized by and/or on one or more computing devices. The application may also be referred to as a dedicated application.

### Methods of Employing the System

The present teachings provide for one or more methods which employ the one or more pet health devices, sensing devices, system, or a combination thereof as disclosed herein. The one or more methods may be employed individually, sequentially, simultaneously, overlap, cooperate together, or a combination thereof. The one or more methods may be one or more methods executable by one or more computing devices as disclosed in the present teachings. The one or more methods may stored in one or more storage mediums, accessible and executable by one or more processors, or both. The one or more methods may be automated. The one or more methods, or steps thereof, may be automatically executed by one or more processors. The one or more methods may be stored on a non-transient computer readable medium as instructions for causing one or more computing devices to execute the one or more methods.

The one or more methods may be executed locally, remotely, or as a combination of both relative to one or more pet health devices, computing devices, or both. For example, an animal detection method may be executed locally on a pet health device and/or camera while an animal identification method, behavior method, trend method, and/or notification method may be performed remotely on a remote server (e.g., cloud computing). This hybrid may be referred to as edge-computing. It is possible for the models generated by the various methods may be executed locally and updated remotely. It is possible that some models may be performed locally while other models are performed remotely. For example, an animal detection model may be performed locally on a computing device of a pet health device and/or camera while an animal identification model is performed remotely on a remote server (e.g., cloud computing). This hybrid approach may be referred to as edge-computing.

The one or more methods may include a method for animal detection, a method for animal identification, a method of collecting data, a method of learning one or more patterns or trends, a method of generating one or more notifications, the like, or a combination thereof.

### Method for Animal Detection

The present teachings provide for a method of detecting an animal at (e.g., near, within, adjacent) a pet health device. Animal detection may allow for data about the animal and/or the pet health device to be collected, one or more operations of a pet health device to commence, and the like. Detecting of an animal may be based on an animal's presence, weight, body temperature, proximity with an identifier, the like, or any combination thereof. One or more sensing devices which may aid in detecting an animal's presence include one or more cameras, mass sensors, temperature sensors, laser sensors, identification sensors, touch sensors, the like, or any combination thereof. One or more image signals, mass signals, temperature signals, laser signals, identification signals, touch signals, and/or the like may be compared to one another to verify detection of an animal, presence of an animal at a pet health device, usage of a pet health device by an animal, the like, or a combination thereof. The one or more status signals may be compared locally at a controller of a pet health device, remotely via an edge-computing device and/or cloud-computing device, or both.

The method may include detecting the presence of an animal by detecting a change in mass by one or more mass sensors. One or more pet health devices may include or be associated with one or more mass sensors. The method may include using the mass sensors for animal detection as disclosed in U.S. Pat. Nos. 9,433,185; 11,399,502; 11,523,856 incorporated herein by reference in their entirety. It is possible that one or more mass sensors may falsely recognize the presence of an animal at a pet health device. For example, when an animal approaches a litter device or other pet health device out of curiosity, steps up onto a step or rim, inserts their head into a chamber, and the like, without actually using the pet health device. To avoid this increased mass being recognized as an animal at the pet health device for usage (e.g., inside the chamber), consecutive readings over a pre-determined period of time (e.g., short period of time) from a mass sensor(s) may be captured. If the mass detected by the mass sensors stays elevated for the predetermined period of time, this may indicate the presence of the animal. The pre-determined period of time may be 1 second or more, 2 seconds or more, or even 3 seconds or more. The short period of time may be 10 seconds or less, 5 seconds or less, or even 4 seconds or less. To avoid a temporary mass increase being recognized as an animal at the pet health device, the one or more mass sensors may cooperate with one or more other sensing devices. For example, with one or more lasers, cameras, temperature sensors, and/or identification sensors. For example, one or more mass signals may be automatically compared to one or more laser signals, temperature signals, image signals, and/or identification signals by one or more controllers, computing devices, or both. A mass sensor sensing a change in mass may trigger one or more cameras to initiate a video steam to identify presence of an animal. may trigger one or more laser sensors to monitor for the presence of an animal. may trigger one or more temperature sensors to monitor for an increase in temperature thus identifying the presence of an animal, may trigger one or more identification sensors to scan for proximity of one or more identifiers, the like, or a combination thereof.

The method may include detecting the presence of an animal by detecting the proximity of one or more identifiers by one or more identification sensors. One or more pet health devices may include or be associated with one or more identification sensors. The method may include using the one or more identification sensors for animal detection as disclosed in PCT Publication No. WO2020/061307 and WO2022/058530, incorporated herein by reference in their entirety. The challenge may be presented that one or more identification sensors may falsely recognize the presence of an animal at a pet health device, may recognize close proximity to a pet health device as physical presence at the pet health device, or both. For example, as an animal with an identifier approaches a litter device, feeder, or even water dispenser having an identification sensor, such as walking past or approaching out of curiosity, the identification sensor may establish communication with the identifier. To avoid short moments near the proximity of the identification sensor triggering animal detection, the one or more identification sensors may monitor for proximity of the identifier for a pre-determined period of time (e.g., short period of time) before recognizing proximity as presence (e.g., 3 seconds or greater), cooperate with one or more cameras, cooperate with one or more mass sensors, one or more lasers, one or more other sensing devices, the like, or any combination thereof. An identification sensor sensing an identifier may trigger (or even compare data being monitored) one or more mass sensors to monitor for an increase in mass, may trigger one or more laser sensors to monitor for the presence of an animal, may trigger one or more temperature sensors to monitor for an increase in temperature thus identifying the presence of an animal, may trigger one or more cameras to initiate a video stream to identify a presence of an animal, and/or the like.

The method may include detecting the presence of an animal by one or more cameras detecting an animal approaching and/or using a pet health device. The method may be referred to as a visual detection method. The visual detection method may be accessible by, stored within, and/or executed by one or more cameras, computing devices, applications, processors, the like, or any combination thereof. The visual detection method may be software stored and/or executed locally, remotely, or both. At least a portion of the visual detection method may be stored separate from a camera, be accessible by the camera, be located within a cloud computing server, be located within an edge computing server, or a combination thereof. The visual detection method may be useful in detecting one or more animals at a pet health device, determining duration of use of a pet health device by an animal, determining behavior or both. The visual detection method may be particularly useful in identifying the presence and duration of use of an animal at a litter device, feeder, and/or water dispenser. The visual detection method may be executed via machine learning. Machine learning may include deep learning. neural networks, and the like. The visual detection method may include a plurality of steps. The visual detection method may include one or more of the following steps: creating and/or accessing an initial data set, training, validation, inferring, and ongoing training.

The visual detection method may include creating and/or accessing an initial data set. The initial dataset may function as and/or be referred to as a training dataset. A training dataset may function to train the visual detection method to successfully detect the presence of an animal at a pet health device, a type of animal (e.g., genus, species) at a pet health device, or both. A training dataset may be obtained from already existing datasets, creation of a dataset, or both. A training dataset may be obtained from publicly and/or privately available datasets accessible by the visual detection method. For example, the publicly available COCO dataset made available by the COCO Consortium, incorporated herein by reference in its entirety for all purposes. The COCO dataset is an object detection dataset with images from everyday scenes, including pets. The COCO dataset is already trained to identify some genus of animals, including cats, dogs, mice, birds, and people. A dataset may initially be generated by manually collecting a plurality of digital images of animals (e.g., cat, dog, rabbit, human). Manually collecting may mean the images may be obtained from the web, customers, image collections, etc. as opposed to an already existing public dataset.

Data types for a training dataset may include one or more video streams, still images, frames, sounds, and/or the like. Video streams, still images, frames, sounds and/or the like may capture traits of an animal or be free of traits of an animal. Traits may include specific physical features (e.g., ears, nose eyes, side profile, front profile), the behavior of the animal (e.g., animal approaching camera, animal walking away from camera, animal eating, animal urinating, animal drinking, etc.), or both. Video streams may be broken down into and stored as frames. The training dataset may initially and/or continuously be accessed for initial and ongoing training. An initial training dataset may include about 200 or more images, 500 or more images, 1,000 or more images, or even 1,500 or more images for each type of species and/or genus of animal. An initial training set may include about 20,000 images or less, 15,000 images or less, or even 10,000 images or less for each type of species and/or genus of animal.

An initial training dataset may include background images free of any animals. The background images may be about 1% or more, 5% or more, or even 10% or more of the overall dataset of images. The background images may be about 20% or less, 15% or less, or even 12% or less of the overall dataset of images.

Deep learning or deep neural networks (DNNs) may be suitable for accurately classifying the different parts of video frames. DNN preprocessing may involve converting video streams to individual frames and/or acquiring frames from a database. Before or after the images form a dataset, the images may be labeled or tagged such as to identify a type of animal, such as be species or genus. Preparing the images for the dataset may include bounding the images within the dataset or may be free of (e.g., images in dataset are already bounded). Bounding may include placing a bounding-box (BBox) around a relevant animal(s) within the image. Bounding may include automatically annotating the size (e.g., height, width) and location (center or corners) of the bounding-box on the image.

The visual detection method may include training to create an animal detection model. Training may function to train the algorithm to accurately detect an animal at a pet health device, identify the type of animal. or both. Training may function to train the algorithm using one or more training datasets. Training may utilize one or more training models. Training may be via a supervised model, unsupervised model, or both. Training may be from scratch or using an already pretrained model. A suitable training model may include YOLOv5 (You Only Look Once), incorporated herein by reference in its entirety for all purposes. Pretrained datasets for use with a training model may be available with COCO, VOC, Argoverse, ViDrone, GlobalWheat, xView, Objects365, SKI-110K, and the like, all of which are incorporated herein by reference for all purposes. Pretrained models may come with classes already available for animal types, such as species and/or genus (e.g., cat, dog, person). Training may include feature extraction, output prediction, or both. Feature extraction may be referred to as a backbone layer(s) of a training model. Output prediction may be referred to as a head layer(s) of a training model. Training may include fine tuning. Fine tuning may include iteratively executing the generated animal detection model on the training dataset. The visual detection method may include validating. Validating evaluates the animal detection model created via the training step. Validating may include executing validation script. The validation script may include already identified correct detection of an animal, type of animal, behavior of animal, the like, or a combination thereof. Validating can be completed via a training dataset, a second validation/testing dataset, or the like. After validation, the animal detection model is ready for inference.

The visual detection method may include executing the animal detection model for inference. Executing the animal detection model may identify the presence of an animal at a pet health device, a type of animal, or both. A camera may detect an object in view of an image sensor, may detect a change in the scene being monitored, may be triggered to initiate a video stream by a change in status detected by one or more other sensing devices, or any combination thereof. One or more other sensing devices may also detect the presence of an animal and/or confirm the presence of an animal. The video stream is stored one or more video streams, still images (e.g., images), frames, sounds, or a combination thereof. Upon the video stream being broken down and generating frames or images, the animal detection model may be executed. Specific features may be extracted to be isolated and extracted from the resulting data. For example, the animal itself may be isolated and extracted from the background, a portion of the image having the animal may be zoomed into while the remainder of the image is cropped, or both. Inferring may include augmentation. Augmentation may mean that each image is flipped in a different direction (e.g., horizontal) and analyzed at 2 or more different resolutions and analyzed using the animal detection model. Executing the animal detection model may include bounding the detected animal(s) in the image within a box (i.e., bounding-box). Executing the animal detection model may then include determining the animal type (e.g., class, species, and/or genus) of the animal within the bounding-box (aka: inferring). Executing the animal detection model may include determining a pet health device in proximity to the animal, behavior of the animal, behavior of the animal relative to the pet health device, the like, or a combination thereof. Upon the inference, the results may be automatically saved into a the training database, subsequent database. or both. The results may be utilized for ongoing training of the animal detection model. Upon the inference, detection of the animal may also be transmitted to one or more other algorithms related to one or more pet health devices, applications, or both. The resulting inference may be used in lieu of or supplement one or more other means of detecting an animal at a pet health device. For example, in lieu of or in combination with one or more mass sensors, identification sensors, and/or laser sensors of a pet health device.

The visual detection method may include ongoing training. The ongoing training may function to continuously improve the animal detection model. Ongoing training may include storing data collected during execution of the animal detection model. The data may include video streams, frames, images, and the like. The data may be aggregated to the initial training database, added to a subsequent database, or both. Training and validating of the animal detection model, as described above, may be repeated with the new data. The repetitive iterations of training and validating may occur on a recurring basis. The recurring basis may be once per day, once per week, once per month, or the like. The ongoing training may be supervised, non-supervised, or both.

Upon an animal being detected or no longer detected via the visual detection method, one or more operations of one or more pet health devices may be automatically executed or paused. One or more operations may be any operation of a pet health device as disclosed herein or incorporated by reference. One or more operations may be any automatically executable operation of a pet health device to maintain the pet health device, meet a need of an animal (e.g., hunger, thirst, need to alleviate waste), prevent danger to an animal (e.g., consuming food not intended for that animal), the like, or a combination thereof. The one or more operations may be controlled by respective controllers of the one or more pet health devices, may be transmitted directly from a camera to a controller, may be transmitted over the network to the one or more controllers, or a combination thereof. The visual detection method may generate one or more instruction signals. The visual detection method upon making an inference may transmit the determined inference to one or more computing devices. The one or more computing devices may determine an instruction signal associated to the inference, associated with one or more other status signals, or both. The one or more instruction signals may be received by the one or more controllers.

One or more operations executed and/or paused may include:
upon detection of an animal at or near a litter device, a cleaning cycle of a litter device may be paused;
upon detection of an animal at or near a litter device, ambient lighting of a litter device may be turned on;
upon detection of an animal at, within, or near a litter device, monitoring of mass by one or more mass sensors may be initiated;
upon detection of an animal leaving a litter device, a cleaning cycle may be initiated;
upon detection of an animal leaving a litter device, an ambient light may be turned off;
upon detection of an animal at or near a litter device, one or more doors of a litter device may be opened or closed;
upon detection of an animal type allowed into a litter device (e.g., cat), one or more doors of a litter device may be opened;
upon detection of an animal type not allowed into a litter device (e.g., dog), one or more doors of a litter device may be closed;
upon detection of an animal at or near a feeder, dispensing food into a serving dish;
upon detection of an animal at or near a feeder, dispensing an open container of food into a feeding area;
upon detection of an animal at or near a feeder, a lid may be opened to allow the animal access to the food;
upon detection of an animal at or near a feeder, automatic measuring of the current amount of food available to be consumed may be initiated:
upon detection of an animal leaving a feeder, a lid may be closed to prevent other animals having access to the food and/or the food remaining fresh;
upon detection of an animal leaving a feeder, automatically measuring the amount of food remaining to determine an amount consumed by the animal; upon detection of an animal at or near a water dispenser, dispensing and/or commencing circulation of water into a serving dish, filtering water, or both;
upon detection of an animal at or near a water dispenser, activating one or more mass sensors or other water level sensors to obtain a measurement prior to any consumption;
upon detection of an animal leaving a water dispenser, measuring a mass or other sensed conditions to obtain a measurement after consumption;
upon detection of an animal leaving a litter device, determining an amount of litter remaining in a litter storage portion and if litter should be replenished;
upon determining litter should be replenished, automatically ordering litter via an online marketplace;
upon detection of an animal being done at a feeder, determining an amount of food remaining in a hopper or other storage portion and if food should be replenished;
upon determining food should be replenished, automatically ordering food via an online marketplace.

The method for animal detection may also serve to detect one or more humans at or near a pet health device. In the same manner as visually detecting an animal, the system may be employed for detecting a human. The method may detect an adult versus a child. The system may need to be trained as described above to determine the presence of a human and subsequently or simultaneously identify a general age of the human. Upon detecting the presence of a human, one or more operations of a pet health device may be executed or paused. The operations may be the same or similar as listed above. This may allow for a human to take an action with the pet health device. For example, refill with litter, remove waste, fill with food, fill with fresh water, clean a serving dish, and the like. This may also prevent a human from any accidental, unsafe, or unsanitary interactions with a device. For example, a child sticking their hand inside of a chamber while at rest or in a cleaning cycle, accessing and eating food intended for a pet, setting off one or more mass sensors and triggering another action intended for an animal, and the like. Upon detecting a child. one or more user controls on a pet health device may be automatically rendered inoperable (e.g., locked out). This may be useful in avoiding a child triggering any operations of the pet health device.

### Method for Animal Identification

The present teachings provide for a method of identifying an animal at (e.g., near, within, adjacent) a pet health device. Animal identification may allow for data about a specific animal and/or the pet health device to be collected, one or more operations of a pet health device to commence, one or more trends regarding an animal's use of health device(s) and/or their health to be determined, detecting one or more health conditions of an animal, and the like. Identifying of an animal may be based on an animal's presence, weight, proximity with an identifier, the like, or any combination thereof. Identifying an animal may identify an animal from data specific for a household, across a portion of the system, or even data across the entire system. One or more sensing devices may be used for the method of identifying an animal at a pet health device. One or more sensing devices which may aid in identifying an animal's presence include one or more cameras, mass sensors, temperature sensors, laser sensors, identification sensors, touch sensors, the like, or any combination thereof.

The method may include identifying an animal by mass via one or more mass sensors. One or more pet health devices may include or be associated with one or more mass sensors. The method may include using the mass sensors for animal detection as disclosed in U.S. Pat. Nos. 9,433,185; 11,399,502; 11,523,856 incorporated herein by reference in their entirety for all purposes. Identification via mass may occur as disclosed in U.S. Provisional Application No. 63/517,729, which is incorporated herein by reference in its entirety for all purposes. One or more animals may be associated with a weight, weight range, household, user account, and/or the like. Upon one or more mass sensors detecting a mass, a change of mass, detecting a change of mass as the presence of an animal, or a combination thereof, the mass or change in mass may be correlated to one or more databases. The detected mass or change in mass may be matched to an animal associated with the pet health device, household, user account, and/or the like. Animal identification by mass may be limited to comparing against animals within a same household, part of the same user account, or the like, due to the abundance of data that may exist in the system as a whole. The identification of the animal detected via mass may be compared to the identification of the animal compared to other sensing devices. In other words a mass status signal may be compared to a laser signal, identification signal, image signal, and/or the like.

The method may include identifying an animal with one or more identification sensors. One or more pet health devices may include or be associated with one or more identification sensors. The method may include using the one or more identification sensors for animal identification as disclosed in PCT Publication No. WO2020/061307 and WO2022/058530, incorporated herein by reference in their entirety. As discussed hereinbefore, an animal may wear, have embedded therein, or otherwise by associated with an identifier. The identifier may carry identification data associated with the animal. As an animal is in close proximity, within, adjacent to, a pet health device, an identification sensor may establish communication with the identifier. The identification sensor may receive the identification data from the identifier, receiving identification data which is then correlated to a database, or both. Upon receiving the identification data. the identification of the animal may be determined. The identification of the animal detected via identifier may be compared to the identification of the animal compared to other sensing devices. In other words an identification status signal may be compared to a mass signal, laser signal, image signal, and/or the like.

The method may include visually identifying approaching and/or using a pet health device. The method may be referred to as a visual identification method. The visual identification method may be accessible by, stored within, and/or executed by one or more cameras, computing devices, applications, processors, the like, or any combination thereof. The visual identification method may be software stored locally, remotely, or both. At least a portion of the visual identification method may be stored separate from a camera, be accessible by the camera, be located within a cloud computing server, be located within an edge computing server, or a combination thereof. The visual identification method may be useful in identifying one or more specific animals at a pet health device, determining duration of use of a pet health device by a specific animal, correlating identification data with other data to determine one or more trends or conditions of the animal, or any combination thereof. The visual identification method may be particularly useful in identifying an animal with accuracy, identifying the presence and duration of use of an exact animal at a litter device, feeder, and/or water dispenser, collecting individual animal data relative, or any combination thereof. The visual identification method may be executed via machine learning. Machine learning may include deep learning, deep metric learning, neural networks, and the like. The visual identification method may include a plurality of steps. The visual detection method may include one or more of the following steps: creating and an initial data set, training, validation, inferring, and ongoing training.

The visual identification method may include creating and/or accessing an initial data set. The initial dataset may function as and/or be referred to as a training dataset. The training dataset may for the visual identification method may be separate or same as the training dataset for the visual detection method. A training dataset may function to train the visual identification method to successfully identify an animal at a pet health device. A training dataset may be obtained from already existing datasets, creation of a dataset, or both. A training dataset may be obtained from privately available datasets accessible by the visual identification method. Privately available datasets may be aggregated with publicly available datasets. For example, the publicly available COCO dataset made available by the COCO Consortium, incorporated herein by reference in its entirety for all purposes. A class of data of a public dataset (e.g., cats or dogs in COCO) may be associated with class(es) of data in a private dataset (e.g., individual cats or dogs). For example, a plurality of individual cats (and their identities) may be associated as a subclass of the general cat class in the COCO dataset. A dataset may initially be generated by manually collecting a plurality of digital images of animals (e.g., cat, dog, rabbit, human) and data associated with their identity (pet name, user account, household, user address, breed, weight, age, gender, and the like). Manually collecting may mean the images are obtained from test users, employees, customers, and the like as opposed to an already existing public dataset.

Data types for training may include one or more video streams, still images, frames, sounds, and/or the like. Video streams, still images, frames, sounds and/or the like may capture specific characteristics or traits of an animal or be free of traits of an animal. Traits of an animal may include specific features, the behavior of the animal, or both. Video streams may be broken down into and stored as frames. The training dataset may initially and/or continuously be accessed for initial and ongoing training. A public dataset. on its own, may not be sufficient to create an identification training database. as public data is typically not associated with identities of animals. A public dataset may need to be manually edited to append identities to individual animals. An initial training dataset may include about 200 or more images, 500 or more images, 1,000 or more images, or even 1,500 or more images for each type of species and/or genus of animal. An initial training set may include about 20,000 images or less, 15,000 images or less, or even 10,000 images or less for each type of species and/or genus of animal.

An initial training dataset may include background images free of any animals. The background images may be about 1% or more, 5% or more, or even 10% or more of the overall dataset of images. The background images may be about 20% or less, 15% or less, or even 12% or less of the overall dataset of images.

Deep learning or deep neural networks (DNNs) may be suitable for accurately classifying the different parts of video frames. DNN preprocessing may involve converting video streams to individual frames and/or acquiring frames from a database. Before or after the images form a dataset, the images may be labeled or tagged such as to identify an animal, such as be species or genus. Preparing the images for the dataset may include bounding the images within the dataset or may be free of (e.g., images in dataset are already bounded). Bounding may include placing a bounding-box (BBox) around a relevant animal(s) within the image. Bounding may include automatically annotating the size (e.g., height, width) and location (center or corners) of the bounding-box on the image.

Creating an initial data set may including creating a plurality of sample individual animal profiles (in other words, “digital fingerprints”). Creating the sample individual animal profiles may include one or more users uploading information about one or more animals associated with their user account and/or household. Creating one or more animal profiles may include creating and/or populating a pet profile database, a visual recognition database, a test version of the pet profile database and/or visual recognition database, and/or the like. The information may include a plurality of data associated with the identity of the animal. The information may include a plurality of photos and/or video of the animal. The photos may include different views: front profile, side profile, rear profile, a top view, and/or random photo angles. Video may include different views of the animal walking, sitting, sleeping, and/or the like.

Video and photo data may be analyzed for key distinguishing features of the animals. This may occur during creation of the dataset, training, or both. Key features may include color(s) of fur (e.g., overall color and/or markings), eyes, nose, mouth; ear shape; ear height to width ratio; ear to head size and/or width ratio; head to body size ratio; type of tail; type of fur; length of hair (short hair, long hair); gait when walking; the like; or any combination thereof.

The information input into the one or more animal profiles may include further information about the animal including animal's name, age, gender, weight, breed, known health issues, medications, known eating habits, household, user account, address (city, state, country), language preference for understanding verbal commands, and/or the like. The animal profile data may be stored in one or more databases within the system. For example, the animal profile data may be stored within one or more pet profile databases, visual recognition databases. training databases, the like. or any combination thereof. Each test animal profile may be converted into one or more data strings.

The visual identification method may include training to create an animal identification model. Training may function to train the algorithm to accurately identify an animal at a pet health device, in view of the camera, or both. Training may function to train the algorithm using the training dataset. Training may utilize one or more training models. Training may be via a supervised model, unsupervised model, or both. Training may be from scratch or using an already pretrained model. Training may include feature extraction, output prediction, or both. Feature extraction may be referred to as a backbone layer(s) of a training model. Output prediction may be referred to as a head layer(s) of a training model. Training may include evaluating the training datasets, digital profile data, and automatically determining one or more key identification features. A key identification feature may be a feature, physical and captured by a camera and/or otherwise sensed by another sensing device(s), that may accurately identify an animal. Key identification features may include color(s) of fur (e.g., overall color and/or markings), eyes, nose, mouth; car shape; car height to width ratio; car to head size and/or width ratio; head to body size ratio; type of tail; type of fur; length of hair (short hair, long hair); gait when walking; weight; household associated with camera and/or health device, user account associated with camera and/or health device; the like; or any combination thereof. Different key identification features may be identified as strong predictors of an animal's identity based on certain features of an animal. For example, eye color and eye shape may be a better key identification feature for determining the identity of a cat with black fur while ear size and shape and overall face size and shape may be a better key identification feature for determining the identity of a dog with golden fur. Training may determine the data needed for ongoing creation of animal profiles. For example, training may determine that videos showing an animal's gait are unnecessary in an animal profile for accurate animal detection. Training may automatically adjust the inputs into an application for onboarding of one or more animal profiles. The initial step in the animal detection model may be limiting the data to data associated with a user account or household. By limiting the data, the animal identification model may be processed more quickly. Training may include fine tuning. Fine tuning may include iteratively executing the generated animal identification model on the training dataset. The visual identification method may include validating. Validating evaluates the animal identification model created via the training step. Validating may include executing validation script. Validating can be completed via a training dataset, a second validation/testing dataset, or the like. After validation, the animal identification model is ready for inference.

The visual identification method may include onboarding one or more animal profiles. Onboarding the one or more animal profiles may be similar to the creation of the initial dataset and the creation of one or more sample animal profiles. A key difference being that the sample animal profiles are those created prior to training for testing and initial development of the animal identification model while the subsequent animal profiles are for actual inference and ongoing execution of the animal identification model. Creating the individual animal profiles may include one or more users uploading information about one or more animals associated with their user account and/or household. The information may be the same or similar to that inputted as part of the sample animal profiles, incorporated hereinafter. The animal profile data may be stored in one or more databases within the system. The animal profile data may be stored in one or more pet profile databases, visual recognition databases, or both. The animal profile data may be appended to the same database as the initial training database or into a separate database. Each animal profile may be converted into one or more data strings.

The visual identification method may include executing the animal identification model for inference. The animal identification model may be executed simultaneous to and/or after execution of the a visual detection model and/or method. The animal detection model and/or method may overlap with and share steps with the animal identification model and/or method. Executing the animal identification model may identify an animal at or near a pet health device, in view of a camera, or both. One or more other sensing devices may also detect one or more other traits associated with the digital profile of the animal. Independently via captured images or with other sensed data, the animal identification model may identify an animal with substantial accuracy. The incoming video stream may be stored as one or more frames or images. Upon the frames or images being generated, the animal identification model may be executed. Specific features may be extracted to be isolated and extracted from the resulting data. These specific features may be features identified in the digital profile. Inferring may include augmentation. Augmentation may mean that each image is flipped in a different direction (e.g., horizontal) and analyzed at 2 or more different resolutions and analyzed using the animal identification model. Executing the animal identification model may include bounding the detected animal(s) in the image within a box (i.e., bounding-box). Executing the animal identification model may then include determining the class, species, or genus and/or other traits associated with the digital profile of the animal within the bounding-box (aka: inferring). Executing the animal identification model may utilize the same image(s) utilized by the animal detection model. The animal identification model may be executed immediately after the animal detection model, if, an animal is detected. Upon the inference, the results may be automatically saved into a subsequent dataset. The results may be utilized for ongoing training of the animal identification model. Upon the inference, identification of the animal may also be transmitted to one or more other algorithms related to one or more pet health devices, applications, or both. The resulting inference may be used in lieu of or supplement one or more other means of detecting and/or identifying an animal at a pet health device. For example, in lieu of or in combination with one or more mass sensors, laser sensors, and/or identification sensors at a litter device.

The visual identification method may include ongoing training. The ongoing training may function to continuously improve the animal identification model. Ongoing training may include storing data collected during execution of the animal identification model. The data may include video streams, frames, images, digital profile data, and the like. The data may be aggregated to the initial training dataset. Training and validating of the animal detection model, as described above, may be repeated with the new data. The repetitive iterations of training and validating may occur on a recurring basis. The recurring basis may be once per day, once per week, once per month, or the like. The ongoing training may be supervised, non-supervised, or both.

Upon an animal or human (e. g .. adult or child) being identified via the visual identification method and detected or no longer detected via the visual detection method, one or more operations of one or more pet health devices may be automatically executed or paused. One or more operations may include:
upon detection of an animal at or near a litter device, a cleaning cycle of a litter device may be paused;
upon identification of an acceptable animal at or near a litter device, ambient lighting of a litter device may be turned on;
upon detection of an animal at, within, or near a litter device, monitoring of mass by one or more mass sensors may be initiated;
upon detection of an animal leaving a litter device, a cleaning cycle may be initiated;
upon detection of an animal leaving a litter device, an ambient light may be turned off;
upon identification of an animal near a litter device, one or more doors of a litter device may be opened or closed based on identity of the animal;
upon identification of an allowed animal near a litter device, one or more doors of a litter device may be opened;
upon identification of a non-allowed animal near a litter device, one or more doors of a litter device may be closed;
upon detection of an animal at or near a feeder, dispensing food into a serving dish;
upon identification of an allowed animal at or near a feeder, dispensing a food serving amount associated with that specific animal;
upon identification of an allowed animal at or near a feeder, a lid may be opened to allow that specific animal access to the food;
upon identification of an allowed animal at or near a feeder, automatic measuring of the current amount of food available to be consumed may be initiated;
upon identification of an animal leaving a feeder, a lid may be closed to prevent other animals having access to the food and/or the food remaining fresh;
upon identification of a non-allowed animal at or near a feeder, a lid may be closed to prevent the non-allowed animal having access to the food in the feeder;
upon identification of an animal leaving a feeder, automatically measuring the amount of food remaining to determine an amount consumed by that specific animal;
upon detection of an animal at or near a water dispenser, dispensing fresh water into a serving dish, filtering water, or both;
upon identification of an allowed animal at or near a water dispenser, dispensing fresh water into a serving dish, filtering water, or both;
upon identification of an animal at or near a water dispenser, activating one or more mass sensors or other water level sensors to obtain a measurement prior to any consumption;
upon identification of an animal leaving a water dispenser, measuring a mass or other sensed conditions to obtain a measurement after consumption and associating an amount consumed by that specific animal;
upon identification of an animal leaving a litter device or feeder, ordering litter and/or food via an online marketplace if replenishing is needed.

The method for animal identification may also serve to identify one or more humans at or near a pet health device. In the same manner as visually identifying an animal, the system may be employed for identifying a human. The system may need to be trained as described above to determine the identification of a human. Upon identifying a human in proximity to a pet health device, one or more operations of a pet health device may be executed or paused. The operations may be the same or similar as listed above. This may allow or prevent an identified human taking action with a pet health device. Identification may provide a means for designating one or more humans allowed to interact and trigger operations with a pet health device and/or designated one or more humans prevented from interacting and triggering operations of a pet health device. For example, once one or more children of a household are identified, one or more user controls may be automatically rendered inoperable.

An allowed animal may refer to an animal which is intended to use a pet health device. A non-allowed animal may refer to an animal which is not intended to use a pet health device. For example, one or more cats may be allowed animals which are intended to use a litter device while one or more dogs are non-allowed animals which are not allowed to use a litter device. As another example, a specific cat on a diet (e.g., kitten food, overweight, senior cat food) may be considered an allowed animal relative to a specific feeder and a non-allowed animal relative to another specific feeder.

It is possible the animal identification model may not be able to identify an animal. In other words, the animal may not be stored within a pet profile database. This may cause the animal identification model to prompt a user to create a new animal profile such that it can be stored in the pet profile database. The accuracy of the inability to identify an animal may be 80% or greater, 85% or greater, 90% or greater, or even 95% or greater. It is possible the accuracy of the inability to identify an animal may be 100%. The notification may be employed using the method of generating one or more notifications.

### Method of Data Collection

The present teachings relate to a method of collecting data across one or more pet health devices, sensed by one or more sensing devices, or both and storing in one or more databases. The one or more pet health devices may include and/or be associated with one or more sensing devices. The one or more sensing devices may sense data and transmit the data to one or more processors. The one or more processors may be affixed or part of a pet health device, a sensing device, or both. The one or more processors may be located remotely from one or more pet health devices, sensing devices, or both.

Examples of sensed data and associated data from one or more sensing devices may include, but are not limited to:
mass of an animal;
mass of an overall pet health device or a specific portion of the pet health device;
a change in mass which is being monitored;
mass prior to use of a pet health device by an animal;
mass after use of a pet health device by an animal;
mass of a pet health device at a predetermined time or time interval;
timestamp associated with the mass measurement;
status of a pet health device associated with the mass measurement;
time duration associated with an increase or decreased in monitored mass;
temperature of an animal;
temperature of an ambient environment;
timestamp associated with a monitored temperature;
time duration associated with an increase or decrease in temperature;
detection of an object by a laser sensor;
duration of detection of an object by a laser sensor;
timestamp associated with detection by a laser sensor;
identification data from an identifier;
identity of an animal associated with an identifier;
timestamp associated with an identifier being in transmitting distance of an identification sensor;
duration associated with an identifier being in transmitting distance of an identification sensor;
change in status of a touch sensor;
timestamp associated with a change in status of a touch sensor;
duration associated with a change in status of a touch sensor;
acceleration and/or velocity associated with an animal;
timestamp and/or duration associated with an acceleration and/or velocity;
position and/or location of an animal;
timestamp and/or duration associated with the position and/or location;
recording of one or more sounds;
electromagnetic field(s) associated with an animal (e.g., EEG, ECG);
timestamp, duration, and/or location associated with the sound;
biomarkers or vitals including heart rate, blood oxygen level, body temperature, and/or respiratory rate of an animal;
timestamp associated with one or more vital signs of an animal;
one or more streaming videos, frames, and/or images of an animal. an exterior of a pet health device, an interior of a pet health device, and/or an ambient environment;
timestamp associated with the streaming video, frames, and/or images;
identity of an animal;
identity of a specific household;
identify of a user account; and
identity of a pet health device.

Upon being stored, the data may be analyzed to determine one or more trends. behaviors. and/or even health conditions of one or more animals. The data may be analyzed via traditional techniques, artificial intelligence, machine learning, or other techniques.

### Method of Learning One or More Patterns or Trends

The present teachings may relate to a method of determining one or more patterns and/or trends associated with the received data. Machine learning may be used to identify patterns and trends in the stored data. The patterns and trends may be associated with an individual animal, a household, a region, a pet health device, across same or similar health devices, a same genus or species of animal, a same or similar breed of animals, and/or the like.

One or more machine learning methods may be used to determine one or more the patterns and trends. One or more types of machine learning may include regression, instance-based methods, regularization methods, decision tree, Bayesian, kernel methods, association rule learning, artificial neural networks, deep learning, dimensionality reduction, ensemble methods, the like, or any combination thereof. One or more artificial neural networks may include one or more multi-layer neural networks, one or more multi-classification neural networks, or both. A neural network may function by linking a plurality of nodes. The plurality of nodes may be within one or more input layers, hidden layers, output layers, or a combination thereof. The one or more input layers may be associated with one or more data inputs. The data inputs may include the sensed data from the one or more sensing devices, the data associated with the sensed data, or both.

The method may include creating an initial training dataset. The initial training dataset may function to train one or more machine learning to models to identify one or more trends or patterns, identify the type of data and interrelationships of data that may influence the trends or patterns, or any combination thereof. The data may be publicly or privately available. The data may be a collection of data from employees, test users, and/or customers over periods of time. The data may be automatically collected, manually collected, or both. One or more individuals may input data into an application for transferring into a database. The data collected for the initial training dataset may include some, all, or more of the data discussed hereinbefore. Once an initial training dataset is created, one or more machine learning models may be trained.

The method may include training one or more machine learning models to create one or more behavior models. Training may function to train the behavior model to accurately identify one or more trends, patterns, causal relationships, other data interrelationships, or any combination thereof. Training may be via a supervised model, unsupervised model, or both. Training may be employed on a training dataset. Training may lead to identifying the following:
an average duration or range of time of an animal within a litter device associated with urinating;
an average duration or range of time of an animal within a litter device associated with defecating;
an average duration or range of time of an animal urinating or defecating based on breed, age, gender, or other attributes;
a body position of an animal within a litter device associated with urinating versus defecating;
an average weight of urine versus an average weight of fecal matter after elimination;
typical eating, drinking, and/or elimination habits of an animal based on species, genus, breed, gender, and/or age;
typical eating, drinking, and/or elimination habits of an animal based on specific identity;
one or more health conditions (e.g., diseases, pregnancy, growth, aging) associated with eating. drinking, and/or elimination habits and one or more other factors, such as weight of an animal;
movement patterns of an animal within a household and/or outside of the household; and
potential fecal matter elimination locations based on movement patterns of an animal (e.g., identifying fecal matter waste positions in a yard).

The method may include executing one or more behavior models for inference. After training, the one or more behavior models may be executed to make one or more inferences based on the one or more patterns and/or trends of data. The one or more behavior models may be executed with ongoing collected datasets as opposed to a training dataset. Exemplary inferences may include:
if an animal has urinated or defecated based on duration inside of a litter device;
if an animal has urinated or defecated based on position of an animal within a litter device;
if an animal has urinated or defecated based on a measured mass of a litter device after an animal has exited;
if an animal is pregnant based on change in eating, drinking, elimination, and/or body mass;
if an animal is showing signs of sickness based on change in eating, drinking, elimination, body mass, vital signs, and/or other attributes;
a predicted illness or potential illnesses based on change in eating, drinking, elimination, body mass, vital signs, and/or other attributes;
a deviation from typical movement patterns; and
a location of eliminated waste based on movement patterns (e.g., determining location(s) of eliminated fecal matter in a yard, such as for easier pick-up by a pet owner).

The one or more behavior models may include automatically determining a potential presence of one or more health issues. One or more health issues may be associated with deviation of one or more trends. One or more health issues may include a urinary tract infection, hypothyroidism, hyperthyroidism, diabetes, chronic kidney disease, the like, or a combination thereof. A urinary tract infection may be identified by an increase in the frequency of use of the litter device. A urinary tract infection may be identified by an increase in the frequency of use of the litter device without a change in an average amount of liquid or food consumed over a period of time. Hypothyroidism may be identified by a decrease in the average amount of food consumed. Hyperthyroidism may be identified by an increase in the average amount of food consumed. Diabetes may be identified by an increase in use of the litter device and an increase in the frequency of liquid consumed. Chronic kidney disease may be identified by an increase in the frequency of urination. a decrease in the amount of defecation, and/or an increase in the frequency and/or amount of liquid consumed.

The method may include ongoing training of the behavior model(s). The ongoing training may function to continuously improve one or more behavior models. Ongoing training may include storing data collecting during execution of the behavior model(s). The new data may be stored with the initial training data or in a separate database. Continued training may be as described earlier, but inclusive of the new data. The repetitive iterations of training may occur on a recurring basis. The recurring basis may be once per day, once per week, once per month, or the like.

### Method of Generating One or More Notifications

The present teachings provide for a method of generating one or more notifications. One or more notifications may be generated based execution of the method for animal detection, method of animal identification, method of collecting data, method of learning one or more patterns or trends, or a combination thereof. One or more notifications may include one or more passive notifications, active notifications, or both. A passive notification may be understood as a screen (user interface) accessible by a user via a computing device, such as a screen of an application. An active notification is an alert generated on a user interface such as to gain the attention of a user to access their computing device, such as to open the application.

One or more notifications may include notifying a user of one or more recent detected behaviors of an animal, history of behavior of the animal, an identification of an animal, a lack of identification of animal, or combination thereof. The notifications may be specific to a pet health device and/or an animal. One or more notifications may include notifying a user of an identified trend and/or pattern, deviation therefrom, or both. One or more notifications may include notifying a user of a potential health issue related to an animal identified from a method of learning one or more patterns or trends.

### Illustrative Examples

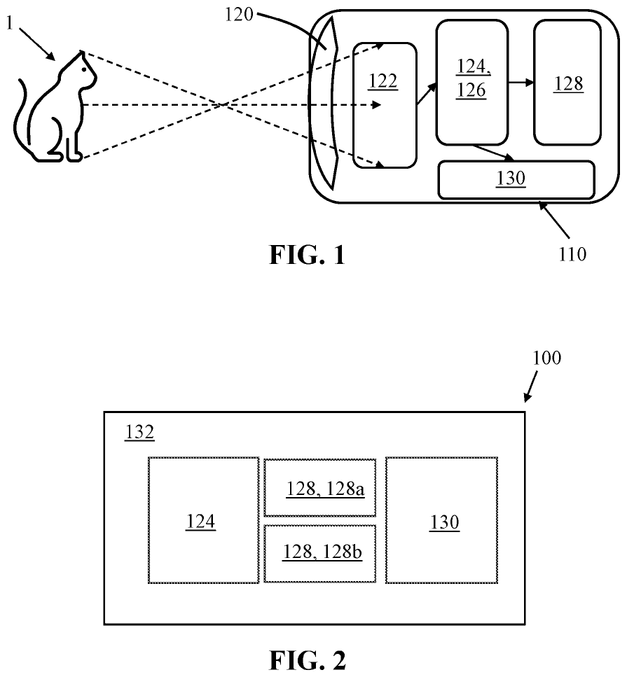

FIG. 1 illustrates an exemplary architecture of a camera 110. The camera 110 is able to capture an object, such as an animal 1, as an incoming video stream. The incoming images come in via a lens 120. The incoming video stream passes the lens 120 and is captured on an image sensor 122. The image sensor 122 is in communication with a processor 124, such as a image processor 126, and a storage medium 128. The camera 110 may also include a communication module 130.

FIG. 2 illustrates an exemplary architecture of a controller 100. The controller 100 may be suitable for controlling one or more pet health devices 20 (not shown). The controller 100 includes a circuit board 132, such as a printed circuit board (“PCB”). The controller 100 includes a processor 124. The controller 100 includes storage medium(s) 128. The storage medium(s) 128 can include volatile memory (“RAM”) and non-volatile memory (“ROM”). The controller 100 further includes or is in communication with a communication module 130.

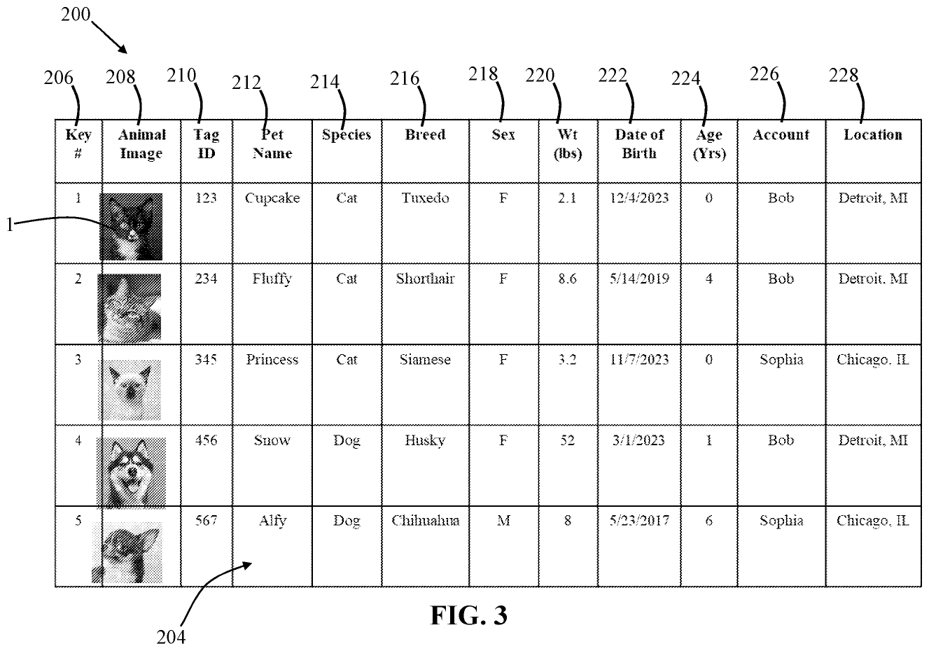

FIG. 3 illustrates a pet profile database 200. A pet profile database 200 may be a local database (e.g., local computing), semi-local (e.g., edge computing) and/or global database (e.g., cloud computing). A local database may be a database for animals specific to a location or subset of locations (e. g .. pets in a home or shelter). A semi-local database may be a database of a number of animals stored on a remote computing device but limited to a specific region or other determining factor. A global database may be a database of all or a variety of animals available stored on a remote computing device.

The pet profile database 202 may include a plurality of data entries 204 associated with each animal 1 stored therein and related to an identify of the animal 1. The data entries 204 per animal may include one or more data keys 206. The data key 206 may be useful for correlating data in one database to data in another database. The data entries 204 may include one or more of the following: images of the animal 208, identifiers or data associated with an identifier 210, respective given names of the animal 212, species of the animal 214, breed of the animal 216, gender of the animal 218, weight of the animal 220, date of birth of the animal 222, age of the animal 224, an account and/or owner of the animal 226, a location of the animal 228, and/or the like.

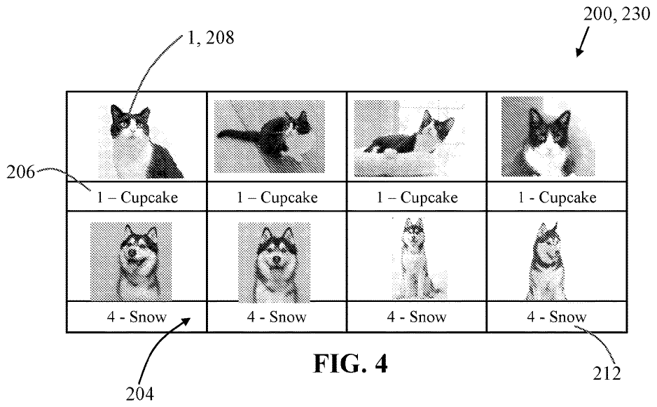

FIG. 4 illustrates a database 200. The database 200 may be a visual recognition database 230. The database 200 may include a plurality of data entries 204. The data entries 204 may include a one or more images 208 of one or more animals 1. For example, there may be a plurality of images 208 associated with each animal 1. Each image 208 may be associated with a specific animal 1 by a data key 206, name 212, or other identifying data. The visual recognition database 230, or other database, may also store images 208 of animals exhibiting certain behavior. For example, drinking water, eating food, eliminating waste (e.g., urine, bowel movement), approaching, leaving, sleeping, scratching, yawning, licking, and/or the like.

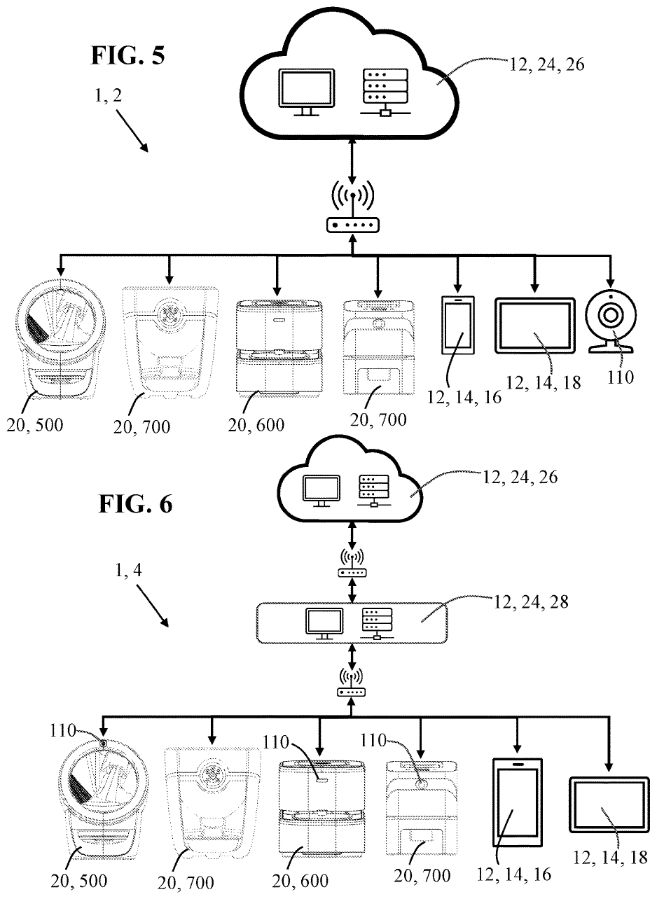

FIGS. 5 and 6 illustrate a system 10. The system 10 includes a plurality of pet health devices 20. The pet health devices 20 include one or more litter devices 500, water dispensers 600, feeders 700. The system 10 includes one or more visual devices 110. The visual device(s) 110 may be separate from the pet health devices 20 (as shown in FIG. 5) or integrated into the pet health device(s) 20 (as shown in FIG. 6) The system also includes one or more computing devices 12. The computing device(s) 12 may be personal computing devices 14. Personal computing devices 14 may include mobile phones 16, tablets 18, and/or the like. The pet health device(s) 20, camera 110, and/or personal computing devices 12 may all be in communication (e.g., two-way) with another computing device 12, such as a remote computing device 24. Communication may be via one or more communication hubs 22 (e.g., router, antenna). The system 10 may be set up as a cloud-computing system 2 or an edge-computing system 4. The edge-computing system 4 may employ an edge-computing server 28 between the devices 20, 14, 110 and a cloud-computing server 26.

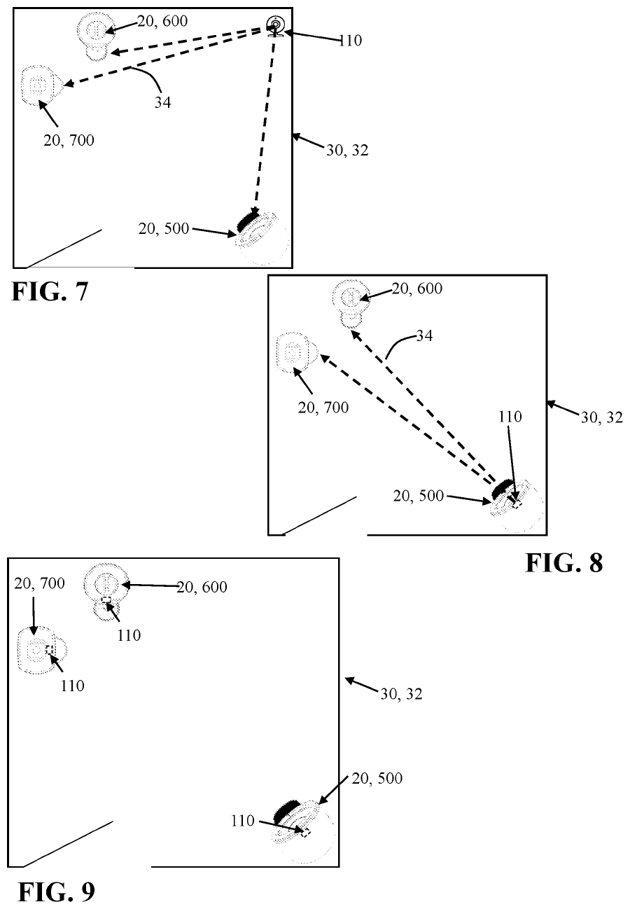

FIGS. 7-9 illustrate various exemplary configurations of a camera 110 relative to a plurality of pet health devices 100 in a setting 30. The setting 30 may be a room 32 or other living space. A camera 110 may be located in the setting 30 such as to have a line of sight 34 onto one or more, or even all, of the pet health devices 20. The camera 110 may be separate from the pet health devices 20, such as shown in FIG. 7. The camera 110 may be integrated into one or more of the pet health devices 20, such as shown in FIGS. 8 and 9. The camera 110 even when integrated may have line of sight onto other pet health devices 20, such as shown in FIG. 8.

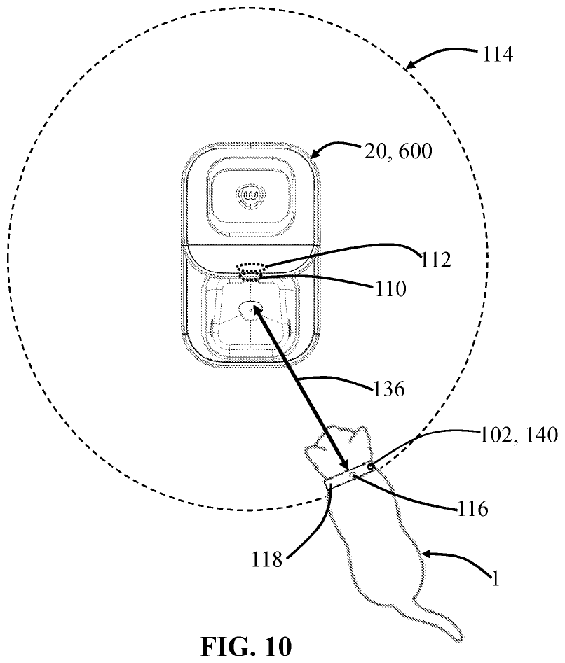

FIG. 10 illustrates a pet health device 20. The pet health device 20 is exemplary shown as a water dispenser 600 but can be any of the pet health devices 20 taught herein or conceivable. The pet health device 20 includes a camera 110. The pet health device 20 also includes an identification sensor 112. The identification sensor 112 has a sensing range 114. As an animal 1 approaches and enters into the sensing range 114, the identification sensor 112 is able to establish communication with an identifier 116. This communication may be referred to as establishing an identification signal 136. As an example, the identifier 116 may be part of or affixed to a collar 118. Any of the methods

[symbol]

The animal 1 may also be associated with one or more animal behavior sensors 140. The animal behavior sensor(s) may also be one or more sensing devices 102. The one or more animal behavior sensors 140 may be part of or affixed to a collar 118.

disclosed herein may be executed upon an animal 1 being detected within the sensing range 114.

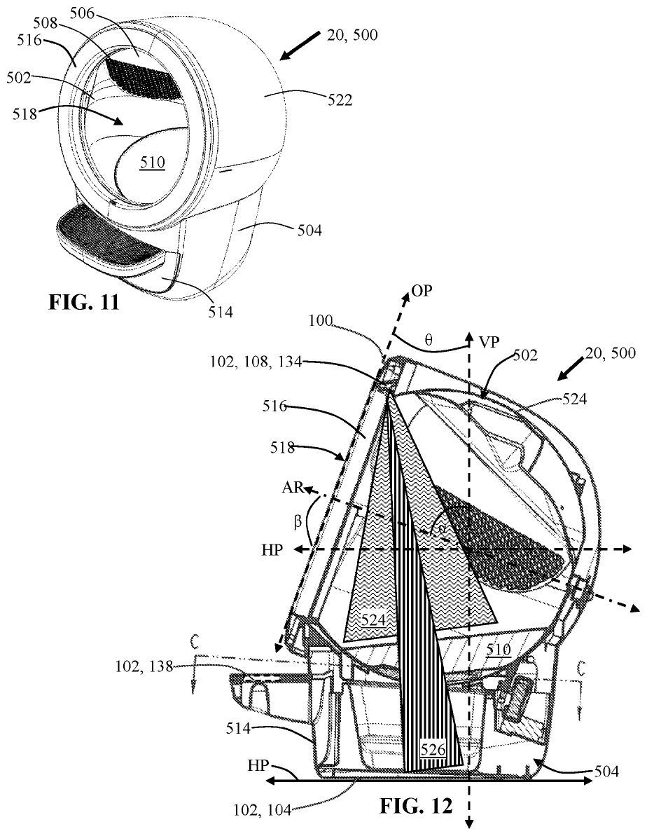

FIGS. 11 and 12 illustrate a litter device 500 as an exemplary pet health device 20. The litter device 500 is an automated litter device. The litter device 500 includes a chamber 502. The chamber 502 defines an entry opening 518. The chamber 502 is partially covered by a bonnet 522. The chamber 502 is rotatably supported on a base 504. Inside the chamber 502 is a septum 506 which includes a sifting portion 508. During a cleaning cycle, the chamber 502 rotates about its rotational axis AR and the sifting portion 508 sifts through litter 510 to segregate waste for disposal. The base 504 incudes a waste receptacle 512. The waste receptacle 512 is shown as a waste drawer 514. The segregated waste exists the chamber 502 and is stored in the waste receptacle 512 for later disposal. The litter device 500 includes a bezel 516. The bezel 516 is located about the entry opening 518. The bezel 516 is statically affixed such that it remains fixed while the chamber 502 rotates. For example, by being affixed to the bonnet 522 and base 504.

The bezel 516 supports a controller 100. The bezel 516 supports one or more sensing devices 102. The sensing device(s) 102 may include one or more laser sensors 108. The sensing device(s) 102 have a line of sight 524 into at least the interior of the chamber 502. The sensing device(s) may also have a line of sight 526 into the waste receptacle 512, such as when a waste opening is rotated during a cleaning cycle and aligns with the waste receptacle 512. The axis of rotation AR is tilted compared to a horizontal plane HP (e.g., ground, plane parallel to ground). This tilting allows for the entry opening 518 and bezel 516 to also be tilted. This angle allows for the sensing device(s) 102 to have line of sight into the interior of the chamber 502 as opposed to solely across the entry opening 518.

The litter device 500 also includes one or more mass sensors 104. The one or more mass sensors 104 may be located at the base 504.

The litter device 500 may include one or more temperature sensors 134 as the one or more sensing devices 102. The one or more temperature sensors 134 may be affixed to the bezel 516.

The litter device 500 may include one or more touch sensor 138 as one or more sensing devices 102. For example, one or more touch sensors 138 may be integrated into a step 526 of the litter device 500.

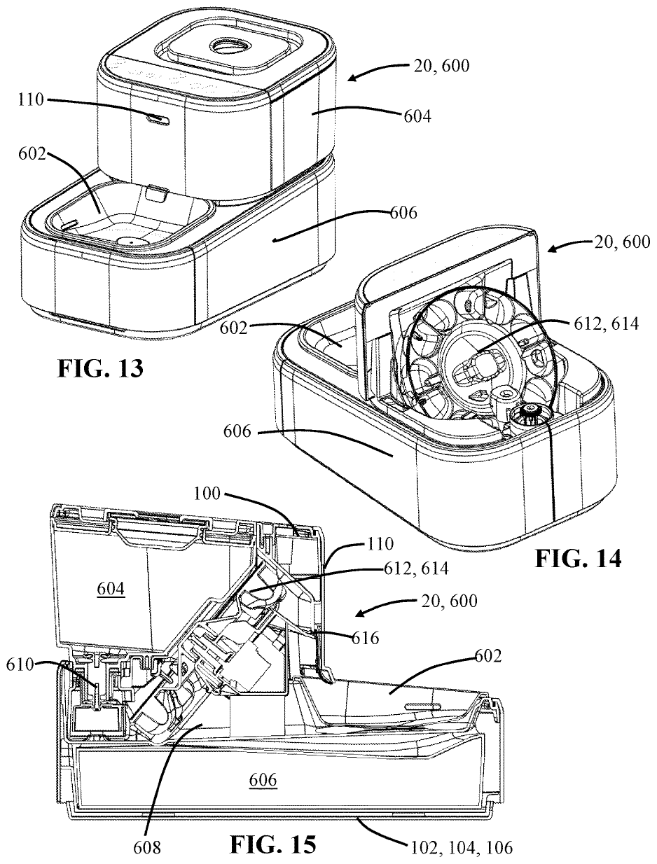

FIGS. 13-15 illustrate a pet health device 20, a water dispenser 600. The water dispenser 600 is an automated water dispenser. The water dispenser 600 includes a serving bowl 602. The water dispenser 602 includes a fresh water tank 604 and a used water tank 606. Inside of the water dispenser 600 is a reservoir 608. The fresh water tank 604 releases fresh water into the reservoir 608 via a valve assembly 610. The water from the reservoir 608 is transported to the serving bowl 602 via an actuation means 612. An example actuation means 612 is a carousel 614. The carousel 614 moves the water toward a spout 616. The water is then able to exit via the spout 616 into the serving bowl 602. The carousel 614 may also work to recirculate water in the reservoir, collect water for disposing into the used water tank 606, or both.

The water dispenser 600 houses a controller 100. The controller 100 may include a printed circuit board (“PCB”).

The water dispenser 600 includes one or more sensing devices 102. One sensing device 102 is illustrated as one or more mass sensors 104. The mass sensors 104 are shown as a scale 106 as the base of the water dispenser 60.

A camera 110 may be located toward the front of the water dispenser 600. The camera 110 may be in electrical communication with the controller 100.

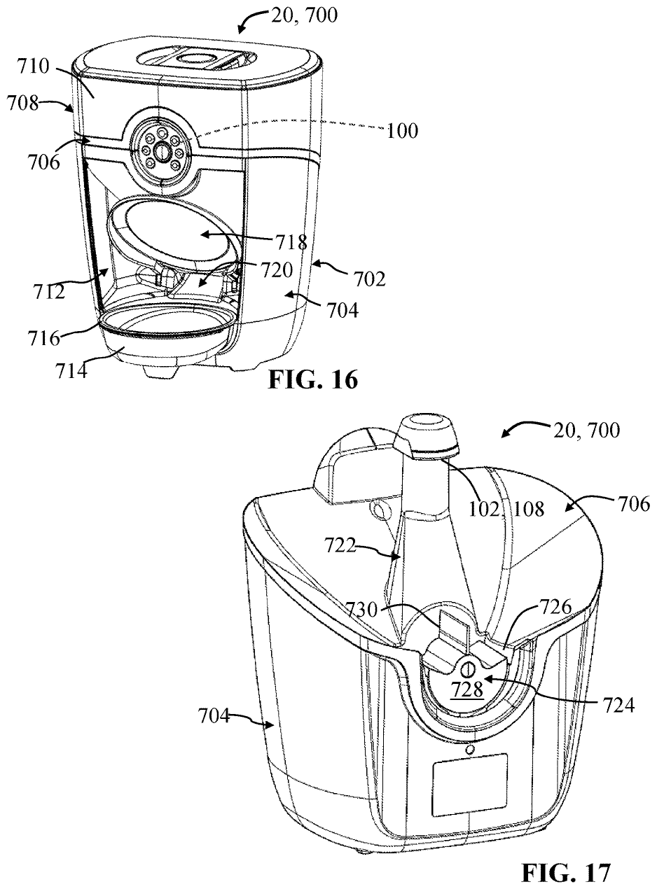

FIGS. 16 and 17 illustrate a pet health device 20, a feeder 700. The feeder 700 is an automated feeder. The feeder may be beneficial in presenting dry (e.g., granular) food to an animal. The feeder 700 includes a housing 702. The housing 702 includes a base portion 704, intermediate portion 706, and a chamber portion 708. The chamber portion 708 includes a hopper 710. Located between the intermediate portion 706 and the base portion 704 is a feeding cavity 712. The base portion 704 includes a serving area 714. The serving area 714 includes a feeding dish 716. The feeder 700 may include a lid 718. The feeding dish 716 may then be able to be covered by a lid 718. The feeding dish 716 is in communication with a chute 720 such that food (not shown) can be transferred into the feeding dish 716 via the chute 720. The feeder 700 includes a controller 100.

The feeder 700 includes a sensing tower 722. The sensing tower 722 houses one or more sensing devices 102. The sensing device(s) 102 may include one or more laser sensors 108. The sensing tower 722 extends through the hopper 710, through the bottom to the top. Thus, the sensing device(s) 102 have a line of sight into the hopper 710.

The feeder 700 includes a dispenser 724. The dispenser 724 is located in a cradle 726. The dispenser 70 includes a rocker body 728 and a fin 730. The rotation of the dispenser 724 results in food stored in the hopper 710 transferring down to the feeding dish 716. For example, via the chute 720.

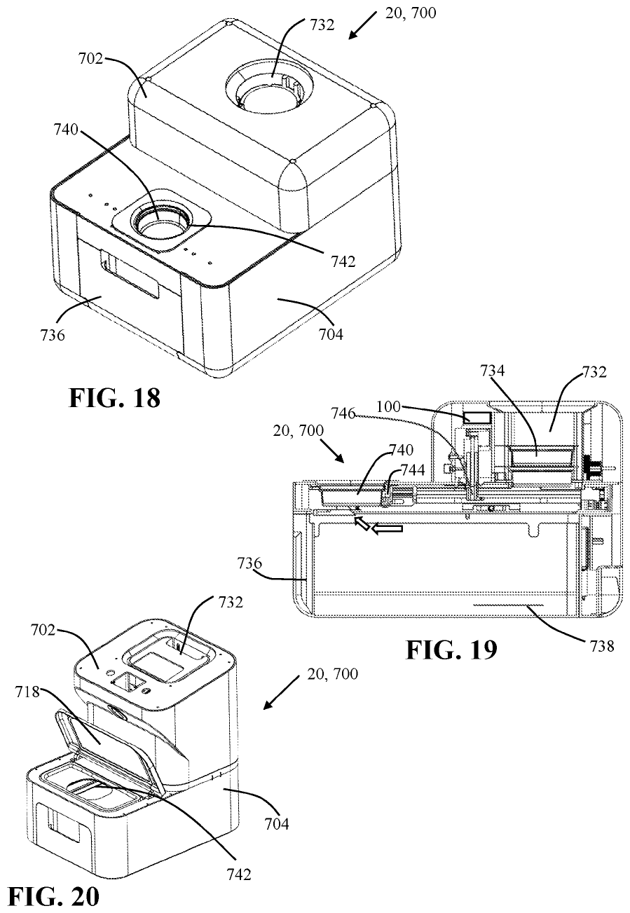

FIGS. 18-20 illustrate a pet health device 20, a feeder 700. The feeder 700 is an automated feeder. The feeder may be beneficial in presented single serve and/or wet food to an animal. The feeder 700 includes a housing 702. The housing 702 provides for a container display opening 742. A container base 740 (e.g., an open container 734) is able to be presented via the container display opening 742 for access and consumption of food held therein by an animal. The feeder 700 may include a lid 718. The lid 718 may close or open such as to conceal or expose the container display opening 742 and/or a container base 740 (e.g., open container 734).

The feeder 700 includes a container storage subassembly 732. The container storage subassembly 732 stores a plurality of containers 734. The housing 702 includes a base portion 704.

The feeder 700 includes a waste collection subassembly 736 located in the base portion 704. The waste collection subassembly 736 is able to receive both a lid 738 and container base 740 of a container 734.

The feeder 700 includes a container handling subassembly 744. The container handling subassembly 744 holds a container 734 after retrieval from a container storage subassembly 732. The container handling subassembly is able to move linearly from the container storage subassembly 732 toward a front, feeding area of the feeder 700. This allows for presentation of the container base 740.

The feeder 700 includes a container opening subassembly 746.

The feeder 700 includes a controller 100. The controller 100 may be affixed in an interior of the feeder 700.

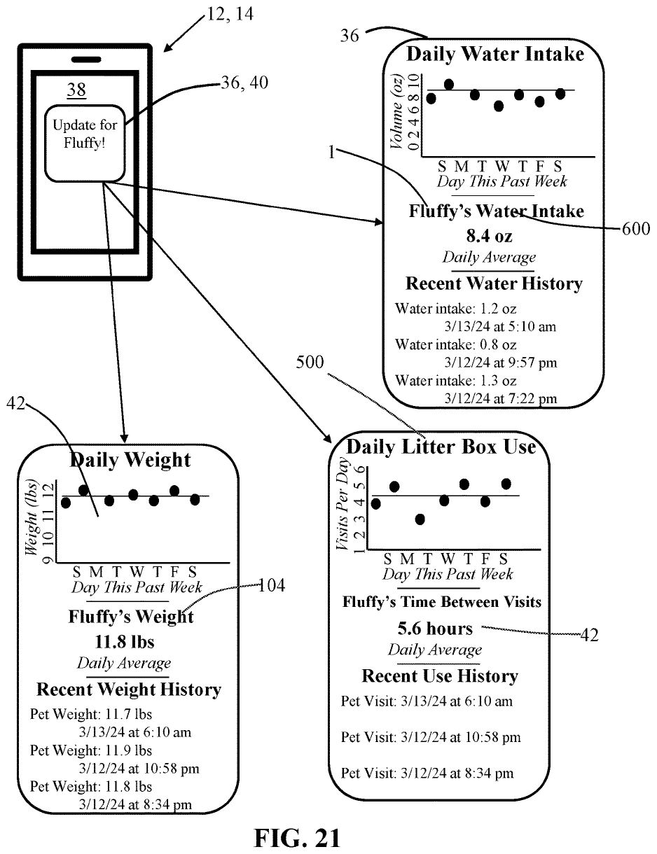

FIG. 21 illustrates varying views (e.g., user interfaces, screens) of an application 36 views on a user interface 38 of a computing device 12. The computing device 12 may be a personal computing device 14 (e.g., mobile phone, tablet). The computing device 12 may have an application 36 running thereon. The application 36 may create and display a notification 40 on the user interface 38. The application 36 may be able to display and notify a user of various data related to an animal and their use of various pet health devices and sensing devices. The application 36 may display data specific to an individual animal 1. The application 36 may display data related to a water dispenser 600, litter device 500, mass sensor(s) 104, and the like. It can be readily apparent how the illustrate relative to water dispenser data could be useful for feeder data. The application 36 may display data related to trends 42 of specific pet health devices, sensing devices, or even across the system.

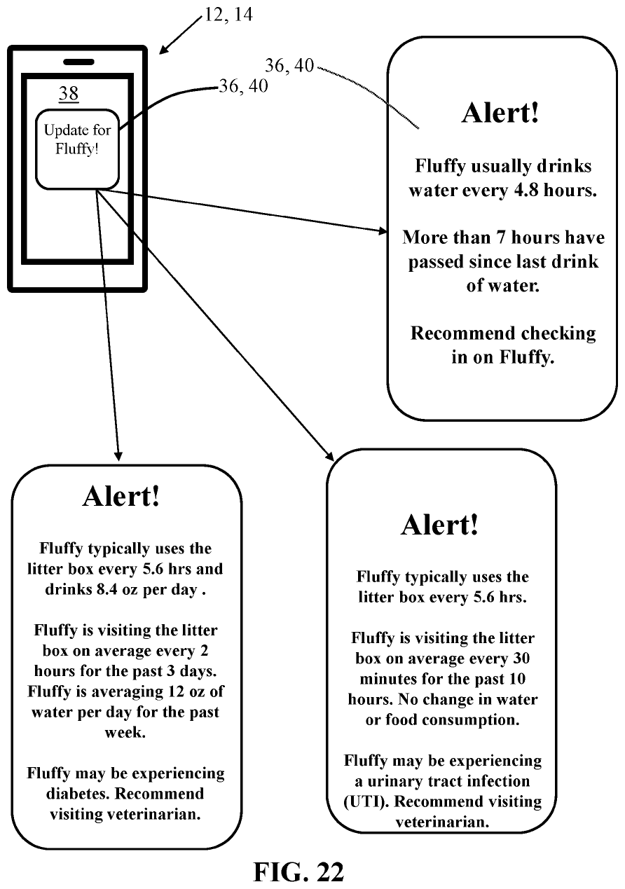

FIG. 22 illustrates varying views of an application 36 views on a user interface 38 of a computing device 12. The computing device 12 may be a personal computing device 14 (e.g., mobile phone, tablet). The computing device 12 may have an application 36 running thereon. The application 36 may create and display a notification 40 on the user interface 38. The application 36 may be able to display and notify a user of deviation from trends specific to an animal and/or pet health device. The application 36 may be able to notify a user of the potential presence of one or more health issues based on one or more identified trends and/or deviations from those trends.

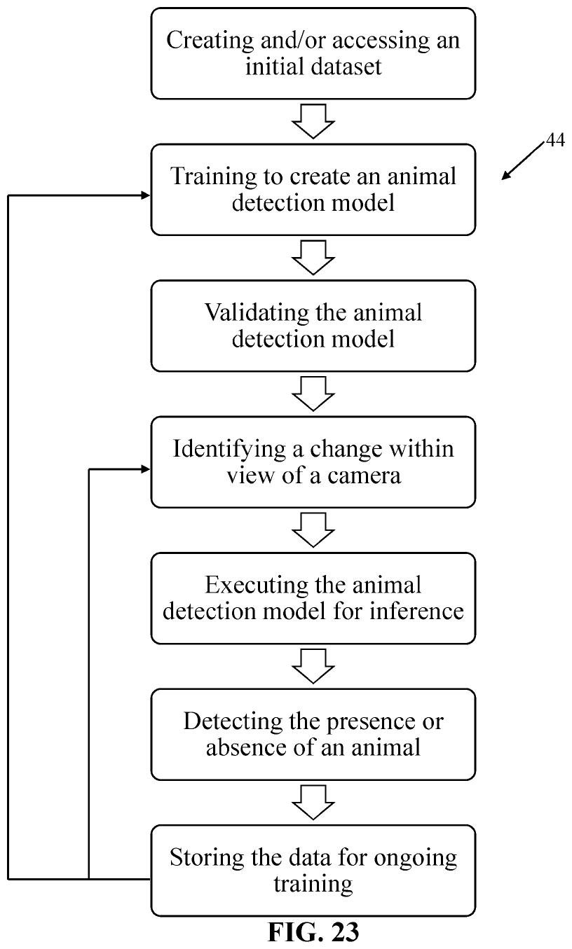

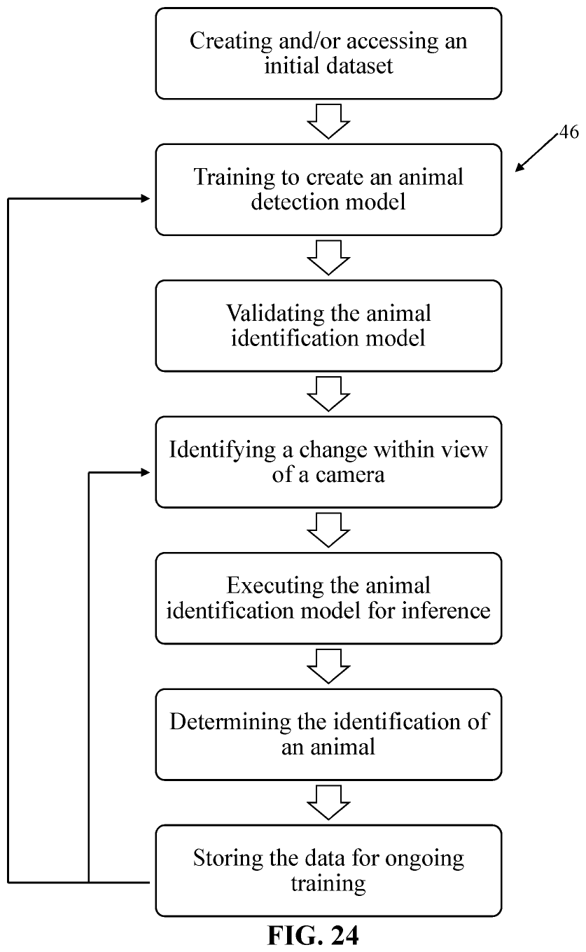

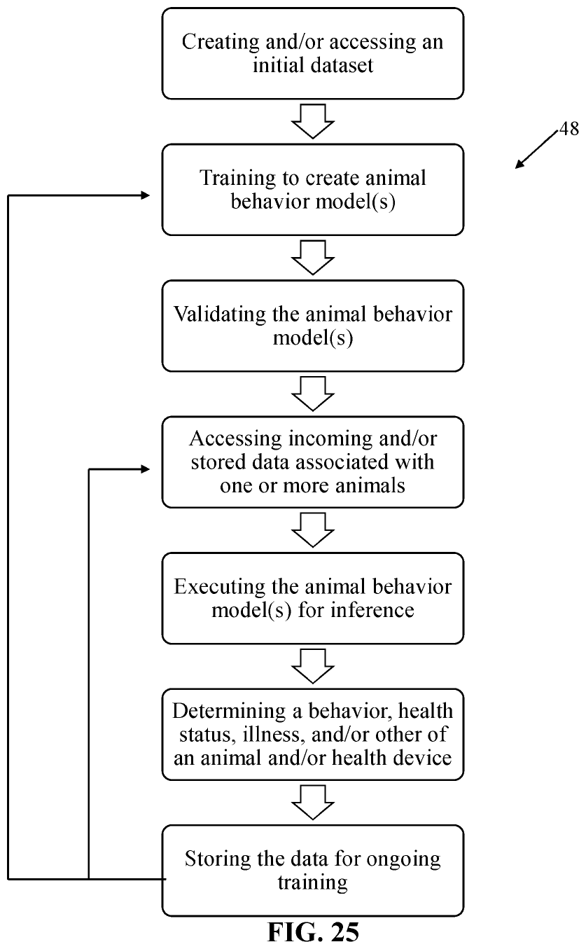

FIGS. 23-25 illustrate various machine learning processes for animal detection, animal identification, and behavior identification. FIG. 23 illustrates the method for animal detection 44. FIG. 24 illustrates the method for animal identification 46. FIG. 25 illustrates the method for behavior identification 48.

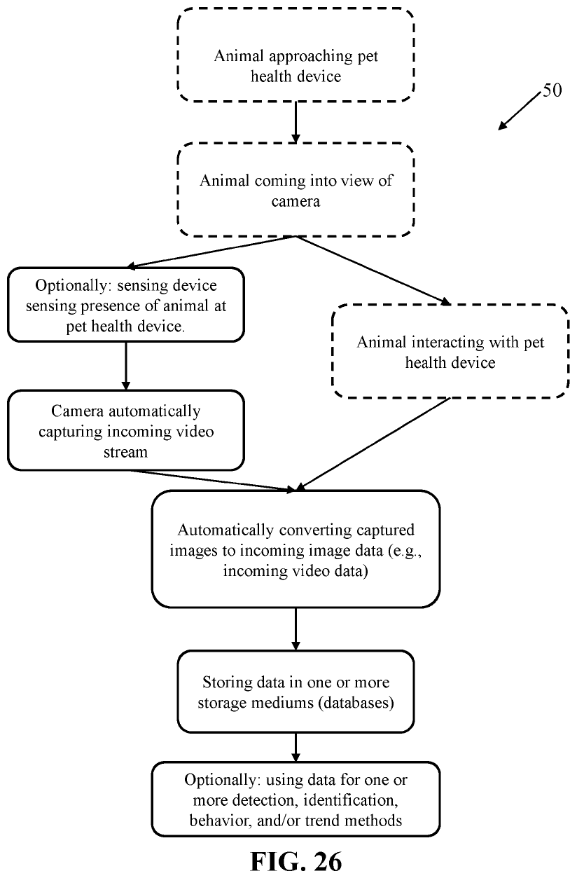

FIG. 26 illustrates a method of initiating a video stream on a camera 50. This method may include an animal approaching a pet health device. The animal may come into view of the camera as the animal approaches. Coming into view of the camera and/or being detected by one or more other sensing devices may trigger a camera capturing an incoming video stream. As an alternative, the camera may be continuously generating a video stream. During this time, the animal may interact with a pet health device. For example, eat, drink, urinate, defecate. The captured video stream may be converted into images and/or frames such as to be usable data. The data may then be stored into one or more storage mediums. The data, once generated, may also be used for one or more subsequent methods, such as those illustrated in FIGS. 23-25.

### REFERENCE NUMBER LISTING

1—Animal: 10—System; 12—Computing device; 14—Personal computing device; 16—Mobile phone; 18—Tablet; 20—Pet Health Device; 22—Communication hub; 24—Remote computing device; 26—Cloud-computing server; 28—Edge-computing server; 30—Setting; 32—Room; 34—Line of sight; 36—Application; 38—User interface; 40—Notification; 42—Trend; 44—Animal detection method; 46—Animal identification method; 48—Behavior identification method; 50—Initiating video stream; 100—Controller; 102—Sensing device; 104—Mass sensor; 106—Scale; 108—Laser sensor; 112—Identification sensor; 114—Sensing range; 116—Identifier; 118—Collar; 120—Lens; 122—Image sensor; 124—Processor; 126—Image processor 128—Storage medium; 128a—RAM (volatile memory); 128b—ROM (non-volatile memory); 130—Communication module; 132—Circuit board; 134—Temperature sensor; 136—Identification signal; 138—Touch sensor; 140—Animal behavior sensor; 200—Database; 202—Pet profile database; 204—Data entries; 206—Data key; 208—Animal image; 212—Name of animal; 214—Breed of animal; 216—Species of animal; 218—Gender of animal; 220—Weight of animal; 222—Date of birth of animal; 224—Age of animal; 226—Account or owner of animal; 228—Location of animal; 230—Visual recognition database; 500—Litter device; 502—Chamber; 504—Base; 506—Septum; 508—Sifting portion; 512—Waste receptacle; 514—Waste drawer; 516—Bezel; 518—Entry opening; 520—Sensing devices; 522—Bonnet; 524—Waste opening; 526—Step; AR—Axis of rotation; HP—Horizontal axis; 600—Water dispenser; 602—Serving bowl; 604—Fresh water tank: 606—Used water tank; 608—Reservoir; 612—Actuation means; 614—Carousel; 616—Spout; 700—Feeder; 702—Housing: 704—Base portion; 706—Intermediate portion; 708—Chamber portion; 712—Feeding cavity; 714—Serving area; 716—Feeding dish; 718—Lid (feeding dish); 720—Chute; 722—Sensing tower; 724—Dispenser; 726—Cradle; 728—Rocker body; 730—Fin; 732—Container storage subassembly; 734—Container; 736—Waste collection subassembly; 738—Lid (container); 740—Container base; 742—Container display opening; 744—Container handling subassembly; 746—Container opening subassembly.

The disclosures of all articles and references, including patent applications and publications, are incorporated by reference for all purposes. The term “consisting essentially of” to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist essentially of, or even consist of the elements, ingredients, components or steps. Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

It is understood that the above description is intended to be illustrative and not restrictive. Many embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventors did not consider such subject matter to be part of the disclosed inventive subject matter.

What is claimed is:

1-18. (canceled)

19. A method for automated animal identification executed by one or more computing devices comprising:
a) optionally, receiving an incoming identification signal from one or more identification sensors integrated in one or more pet health devices, wherein the identification signal is associated with an identifier worn by or embedded in an animal:
b) option ying an incoming mass signal from one or more mass sensors integrated or affixed to the one or more pet health devices:
c) receiving one or more incoming image data signals by a camera in proximity to and/or affixed to one or more pet health devices;
d) transmitting the one or more incoming image data signals from the camera to one or more processors, and optionally transmitting the incoming identification signal and/or the incoming mass signal to the one or more processors;
e) converting the one or more incoming image data signals to one or more image data by the one or more processors and storing in one or more storage mediums, and optionally converting the incoming identification signal to an identification data and/or the incoming mass signal to mass data;
f) executing an animal detection model and analyzing the one or more image data, and optionally the identification data and/or the mass data to determine a presence or an absence of an animal;
g) optionally, transmitting the presence or the absence as data to one or more other algorithms, applications, processors, databases, or any combination thereof;
h) executing an animal identification model and analyzing the image data, and optionally the identification data and/or the mass data, to determine an identification of the animal, wherein the identification is of a specific animal associated with an individual digital animal profile;
i) associating the identification of the animal with other data associated with the animal and a usage of the one or more pet health devices by the animal before transmitting the identification to the one or more storage mediums; and
j) optionally, instructing one or more controllers of one or more pet health devices to execute and/or stop one or more operations of the one or more pet health devices.

20. (canceled)

21. The method of claim 19, wherein the one or more pet health devices include a litter device, a feeder, a water dispenser, or a combination thereof.

22. The method of claim 19, wherein the animal identification model is a machine learning model for visual recognition.

23. The method of claim 22, wherein the method includes creating an initial data set, to train the machine learning model for animal recognition to create the animal identification model.

24. The method of claim 23, wherein the initial data set is a custom created private data set.

25. The method of claim 23, wherein the initial data set includes a plurality of video streams, still images, and/or frames which capture one or more animals and background images free of any animals, and
wherein in the initial data set, each of the plurality of video streams, still images, and/or frames are labeled or tagged to identify the one or more animal by species or genus or a lack of any animal in the background images.

26. (canceled)

27. The method of claim 25, wherein the initial data set includes the digital animal profile associated with the one or more animals captured in the plurality of video streams, still images, and/or frames;
wherein the digital animal profile includes the following information pertinent to each of the one or more animals: a name, an age, a gender, a weight, a species, and a breed; and
wherein the digital animal profile optionally includes one or more of the following for each of the one or more animals: known health issues, one or more medications, one or more known eating habits, a household, a user account, an address, a language preference for understanding verbal commands, or any combination thereof.

28. The method of claim 25, wherein creating the initial dataset includes bounding the one or more animals in the initial data set with a bounding-box to identify a presence of the one or more animal in the video streams, still images, and/or frames.

29. The method of claim 19, wherein the method includes training the machine learning model to create the animal identification model.

30. The method of claim 29, wherein the training includes executing one or more training models; and
wherein the one or more training models identify one or more key identification features from the video streams, still images, and/or frames which identify one or more animals with substantial accuracy.

31. (canceled)

32. The method of claim 30, wherein the one or more key identification features include: color(s) of fur, eyes, nose, mouth; ear shape; ear height to width ratio; ear to head size and/or width ratio; head to body size ratio; type of tail; type of fur; length of hair; gait when walking; weight; household associated with camera and/or health device, user account associated with camera and/or health device; or any combination thereof.

33. The method of claim 19, wherein the analyzing is completed through executing the animal identification model for inference.

34. The method of claim 33, wherein executing the animal identification model includes bounding potentially detected one or more animals in the image data with a bounding box to then automatically determine the presence of the animal in the image data.

35. The method of claim 34, wherein executing the animal detection model includes data extraction of one or more specific features in the image data: and
wherein the data extraction includes extracting one or more key identification features found to be determinative of the identity of the animal in the video streams, still images, and/or frames.

36. (canceled)

37. The method of claim 35, wherein executing the animal detection model includes augmentation.

38. The method of claim 19, wherein upon determining the identification of the animal, the identification and the other data is automatically then transmitted to the one or more other algorithms and/or the processors to execute and/or stop one or more operations of one or more pet health devices, to one or more applications to alert a user via a user interface, or any combination thereof.

39. The method of claim 38, wherein the one or more operations include one more of the following:
a) upon detection of the animal at or near a litter device, a cleaning cycle of the litter device is paused;
b) upon detection of the animal at or near the litter device, an ambient lighting of the litter device is turned on;
c) upon detection of the animal at, within, or near the litter device, monitoring of a mass by the one or more mass sensors is initiated;
d) upon detection of the animal leaving the litter device, the cleaning cycle way is initiated;
e) upon detection of the animal leaving the litter device, the ambient light is turned off;
f) upon identification of the animal near the litter device, one or more doors of the litter device are opened or closed based on identity of the animal;
g) upon detection of the animal at or near a feeder, dispensing food into a serving dish;
h) upon identification of the animal at or near the feeder, dispensing a food serving amount associated with the animal;
i) upon identification of the animal at or near the feeder, a lid id opened to allow that animal access to the food;
j) upon identification of the animal at or near the feeder, automatic measuring of a current amount of food available to be consumed is initiated;
k) upon identification of the animal leaving a the feeder, the lid is closed to prevent other animals having access to the food and/or the food remaining fresh;
l) upon identification of the animal leaving the feeder, automatically measuring the amount of food remaining to determine an amount consumed by the animal;
m) upon detection of the animal at or near a water dispenser, dispensing fresh water into a serving dish, filtering water, or both;
n) upon identification of the animal at or near the water dispenser, activating one or more mass sensors or other water level sensors to obtain a measurement prior to any consumption of water by the animal; and/or
o) upon identification of the animal leaving the water dispenser, measuring a mass or other sensed conditions to obtain a measurement after consumption and associating an amount consumed by the animal.

40. The method of claim 38, wherein the alert is generated on the application and allows for the user to select one or more of the operations of the one or more pet health devices to be executed, allows for one or more other options to be selected, or both.

41-106. (canceled)

107. The method of claim 19, wherein the method includes the receiving of the incoming identification signal from the one or more identification sensors which are integrated in the one or more pet health devices.

108. The method of claim 19, wherein the method includes the receiving of the incoming mass signal from the one or more mass sensors which are integrated into the one or more pet health devices.

109. The method of claim 21, wherein the one or more pet health devices includes the one or more litter devices, wherein each litter device includes a chamber configured to automatically rotate during a cleaning cycle to transfer a waste from within the chamber to a waste receptacle of the litter device.

110. The method of claim 19, wherein the other data includes a sensed data, an associated data derived from the sensed data, or both within the one or more pet health devices and the sensed data, the associated data, or both includes one or more of:
a) mass of the animal;
b) mass of an overall health device or a specific portion;
c) change in a measured mass;
d) a measured mass of the pet health device or portion thereof prior to use of the pet health device by the animal;
e) a measured mass of the pet health device or portion thereof after use of the pet health device by the animal;
f) a measured mass of the pet health device or portion thereof at a predetermined time or time interval;
g) a timestamp associated with the mass measurement of the pet health device or portion thereof;
h) a status of the pet health device associated with the mass measurement;
i) a time duration associated with an increase or decrease in the measured mass of the pet health device or portion thereof;
j) a temperature of the animal;
k) a temperature of an ambient environment in which the pet health device is located;
l) a timestamp associated with a monitored temperature of the animal and/or the ambient environment;
m) a time duration associated with an increase or decrease in the monitored temperature;
n) detection of an object by a laser sensor of the pet health device;
o) a duration of detection of the object by the laser sensor;
p) a timestamp associated with detection by the laser sensor;
q) identification data from an identifier worn by or embedded in the animal;
r) the identity of the animal associated with the identifier;
s) a timestamp associated with the identifier being in transmitting distance of the identification sensor;
t) a duration associated with the identifier being in transmitting distance of the identification sensor;
u) a change in status of a touch sensor of a pet health device;
v) a timestamp associated with a change in status of the touch sensor;
w) a duration associated with a change in status of the touch sensor;
x) an acceleration and/or velocity associated with the animal;
y) a timestamp and/or duration associated with the acceleration and/or velocity;
z) a position and/or location of the animal relative to the pet health device;
aa) a timestamp and/or duration associated with the position and/or location of the animal relative to the pet health device;
bb) recording of one or more sounds of the animal when using the pet health device;
cc) electromagnetic field(s) associated with an animal;
dd) a timestamp, duration, and/or location associated with the sound;
ee) one or more biomarkers and/or vitals including heart rate, blood oxygen level, body temperature, and/or respiratory rate of the animal when in or in proximity to the pet health device;
ff) a timestamp associated with one or more vital signs of an animal;
gg) one or more streaming videos, frames, and/or images of an animal, an exterior of a pet health device, an interior of a pet health device, and/or an ambient environment; and/or
hh) a timestamp associated with the streaming video, frames, and/or images.

111. A method for automated animal identification executed by one or more computing devices comprising:
a) receiving an incoming identification signal from one or more identification sensors integrated in a pet health device, wherein the identification signal is associated with an identifier worn by or embedded in an animal, and is generated when the animal comes into a sensing range of the one or more identification sensors;
b) receiving an incoming mass signal from one or more mass sensors integrated or affixed to the pet health device, wherein the mass signal is either generated or changes when the animal is using the pet health device;
c) receiving one or more incoming image data signals by a camera affixed to the pet health device;
d) transmitting the one or more incoming image data signals from the camera, the incoming identification signal from the identification sensor, and the incoming mass signal from the one or more mass sensors to one or more processors;
e) converting the one or more incoming image data signals to one or more image data, the incoming identification signal to identification data, and the incoming mass signal to mass data by the one or more processors and storing in one or more storage mediums;
f) executing an animal detection model and analyzing the one or more image data, the identification data, and the mass data to determine a presence the animal at the pet health device;
g) optionally, transmitting the presence or the absence as data to one or more other algorithms, applications, processors, databases, or any combination thereof;
h) executing an animal identification model and analyzing the image data, the identification data and the mass data to determine an identification of the animal, wherein the identification is of a specific animal associated with an individual digital animal profile;
i) associating the identification of the animal with other data associated with the animal and a usage of the pet health device by the animal and storing in the one or more storage mediums; and
j) optionally, instructing one or more controllers of one or more pet health devices to execute and/or stop one or more operations of the one or more pet health devices.
